(19) United States
(12) Patent Application Publication
(10) Pub. No.: US 2016/0368207 A1
(43) Pub. Date: Dec. 22, 2016

(54) PRINTING SYSTEMS AND RELATED METHODS

(71) Applicant: ELWHA LLC, BELLEVUE, WA (US)

(72) Inventors: Roderick A. Hyde, Redmond, WA (US); Jordin T. Kare, San Jose, CA (US); Elizabeth A. Sweeney, Seattle, WA (US)

(21) Appl. No.: 14/744,825

(22) Filed: Jun. 19, 2015

(51) Int. Cl. B29C 67/00

(52) U.S. Cl. CPC B29C 67/0055; B29C 67/0088; B33Y 50/02

(57) ABSTRACT

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

In an embodiment, a printing system is disclosed. The printing system includes one or more dispense elements each of which can include at least one dispense aperture. The one or more dispense elements are configured to controllably dispense one or more materials through the at least one dispense aperture. The printing system further includes a barrier including an inner wall at least partially defining an internal region, an outer wall at least partially defining an external region, and a base contact surface extending between the inner wall and the outer wall. The barrier is positioned or positionable so that the one or more dispense elements are positioned in or adjacent to the internal region of the barrier. The printing system also includes a controller including control electrical circuitry that is operably coupled to the one or more dispense elements. The control electrical circuitry is configured to direct dispensing of the one or more materials from the one or more dispense elements.

In an embodiment, a method of three-dimensional printing is disclosed. The method includes positioning one or more dispense elements at least proximate to a region of interest. The method includes at least partially laterally surrounding an internal region with a barrier. The internal region includes at least a portion of the region of interest therein. With the barrier positioned to at least partially laterally surround internal region, responsive to direction from control electrical circuitry, the method further includes controllably dispensing one or more materials from the one or more dispense elements onto the region of interest.

Features from any of the disclosed embodiments can be used in combination with one another, without limitation. In addition, other features and advantages of the present disclosure will become apparent to those of ordinary skill in the art through consideration of the following detailed description and the accompanying drawings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIGS. 1A and 1B are a schematic cross-sectional view and an isometric cutaway view, respectively, of a printing system, according to an embodiment.

FIG. 2 is a flow diagram of a method of using the printing system shown in FIGS. 1A and 1B, according to an embodiment.

FIG. 3 is a schematic cross-sectional view of a printing system, according to an embodiment.

FIG. 4 is a schematic cross-sectional view of a printing system, according to an embodiment.

FIG. 5 is a schematic cross-sectional view of a printing system, according to an embodiment.

FIGS. 6A and 6B are a schematic cross-sectional view and top view of a printing system, respectively, according to an embodiment.

FIG. 7 is a schematic cross-sectional view of a printing system configured to be inserted into an internal region of a body of a subject, according to an embodiment.

### DETAILED DESCRIPTION

Embodiments disclosed herein are directed to printing systems and methods of printing three-dimensional objects. The printing systems disclosed herein are configured to print three-dimensional objects. The printing systems include a barrier configured to at least partially define an internal region, which can at least partially isolate the internal region from an external region. The printing systems also include a printing device configured to print the three-dimensional object on the region of interest.

For example, the region of interest can include a wound (e.g., a dermal wound or internal wound), and the printing system can in situ print a scaffold and a bioink, including cells and extracellular components, to form a tissue graft. For example, in an orthopedic surgical intervention, the printing system can print a polymer scaffold and a bioink including osteocytes to provide a bone graft. For example, when the region of interest is an internal anatomical site, the printing system can print a scaffold suitable for colonization of endogenous cells or tissues. For example, when the region of interest includes an intraabdominal site, the printing system can print all or part of an organ, (e.g., a liver), which can include vascular or microvascular structures. For example, when the internal site includes a solid tumor, the printing system can print a covering of a bioink including a hydrogel and a compound mixture including chemotherapeutics and vascular inhibitors. For example, in an intravascular procedure, the printing system can print a filler for an aneurysm. In an embodiment, the printing system is well suited for printing complex patterns. For example, in a cardiovascular procedure, the printing system can print a patterned cardiac patch directly onto heart tissue (e.g., to support or repair a damaged heart), with the patch including a material having a bioink of elastic hydrogel and a second bioink including cardiomyocytes. For example, the printing system can print onto a region of interest that includes a substrate, biocompatible structures having complex patterns from bioinks including one or multiple structural compounds forming a scaffold and additional bioinks having cells of interest with supportive compounds. These biocompatible structures can be incubated ex vivo, e.g., for cell growth, for use in in vivo procedures. For example, the printing system can print on a region of interest that is an external surface of a body of a living subject, such as the skin, an eye, or an open wound. For example, in a region of interest including a weakened site on a nonorganic surface, such as a joint in a plumbing line, the printing system can print a supportive patch including an adhesive. For example, in a region of interest including a plant tissue having an abrasion, a printing surface can print a plant graft to aid in healing or to introduce a heterogeneous plant to form a hybrid.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here.

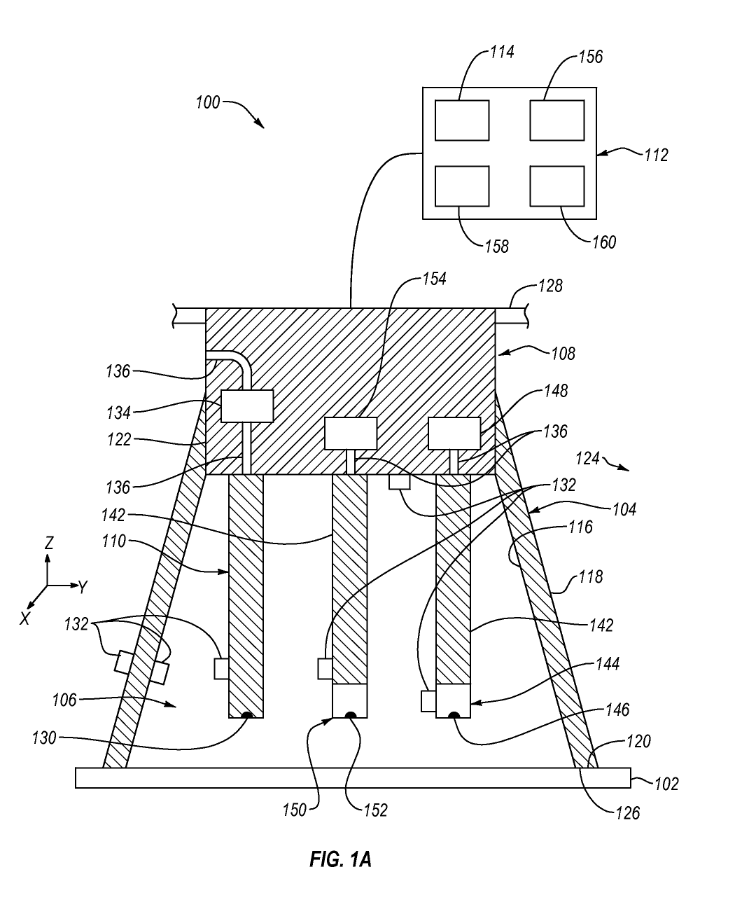

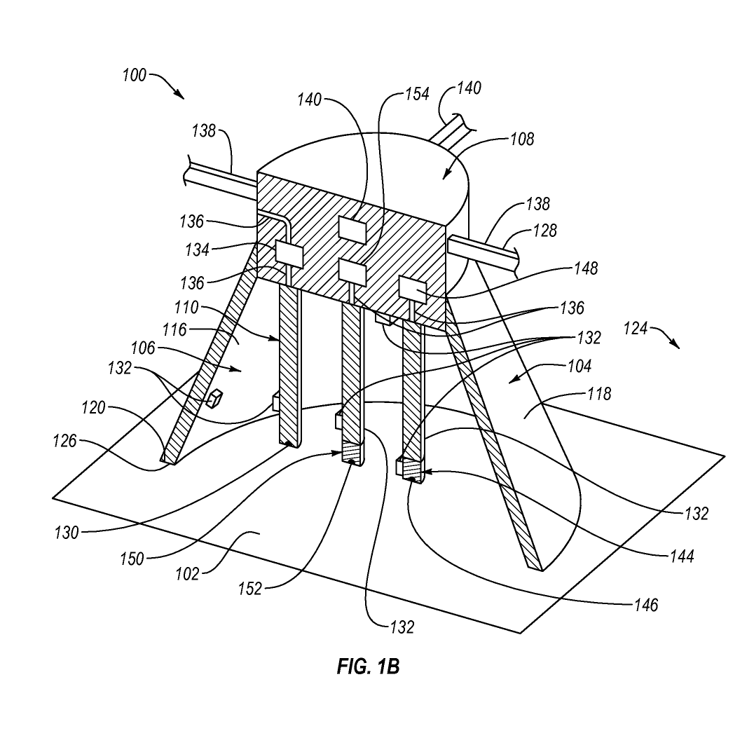

FIGS. 1A and 1B are a schematic cross-sectional view and an isometric cutaway view, respectively, of a printing system 100, according to an embodiment. The printing system 100 can be configured to print an object on a region of interest 102. To accomplish this, the printing system includes a barrier 104 configured to at least partially define an internal region 106. The printing system 100 can further include a printing head 108 configured to support one or more components of the printing system 100. The barrier 104 can be coupled to and extend from the printing head 108. As such, the printing system 100 further includes a printing device, which will be discussed in more detail hereinbelow, configured to dispense one or more materials onto the region of interest 102.

The printing system 100 can further include one or more removal devices 110 configured to remove at least one contaminant or substance from the internal region 106. The printing system 100 can further include a flushing device, which will be discussed in more detail hereinbelow, configured to prepare the region of interest 102 to have the one or more materials dispensed thereon. The at least one removal device 110, at least one component of the printing device, or at least one component of the flushing device can be at least partially positioned in or near the internal region 106. Additionally, the printing system 100 can include a controller 112 including control electrical circuitry 114 configured to control one or more components of the printing system 100.

The barrier 104 can include at least an inner wall 116, a generally opposing outer wall 118, and a base contact surface 120 extending between the inner wall 116 and the outer wall 118. The base contact surface 120 can be distinct or indistinct from the inner wall 116 and the outer wall 118. In an embodiment, the inner wall 116 and the outer wall 118 are merely surfaces of the barrier 104. For example, a portion of the barrier 104 can include a single piece that includes both the inner wall 116 as one surface and the outer wall 118 as an opposing surface. In an embodiment, the inner wall 116 and the outer wall 118 can form distinct pieces of the barrier 104. For example, the inner wall 116 can form a first piece and the outer wall 118 can form a second piece. In such an example, a space can exist between the inner wall 116 and the outer wall 118, the inner wall 116 can at least partially contact the outer wall 118, or a third piece can at least partially occupy the space between the inner wall 116 and the outer wall 118. Similarly, the base contact surface 120 can be a surface of the barrier 104 (e.g., a portion of the barrier 104 can be a single piece including the base contact surface 120, the inner wall 116, and the outer wall 118) or a distinct piece of the barrier 104. The barrier 104 can include additionally surfaces or components. For example, the barrier 104 can include an interfacial surface 122 configured to couple the barrier 104 to the printing head 108.

The barrier 104 can be formed from a single piece or from a plurality of pieces. In an embodiment, the barrier 104 can be formed from a single piece that includes the inner wall 116, the outer wall 118, and the base contact surface 120. In an embodiment, the barrier 104 can be formed from a plurality of interconnected pieces. For example, the barrier 104 can include seams (not shown) between each of the plurality of pieces. For example, the barrier 104 can be formed from a plurality of pieces in which each of the plurality of pieces extends between the inner wall 116, the outer wall 118, the base contact surface 120, and the interfacial surface 122. As such, the seams between the plurality of pieces extend vertically between the interfacial surface 122 and the base contact surface 120. In another example, each of the seams between the plurality of pieces can extend horizontally, (e.g., a first piece extends between the inner wall 116, the outer wall 118, the base contact and the seam while a second piece extends between the inner wall 116, the outer wall 118, the interfacial surface 122 and the seam). In another example, the seams between the plurality of pieces can extend horizontally and vertically, or in any suitable manner. In an embodiment, the seams between the plurality of pieces can be configured to prevent or limit the ability of at least one contaminant from moving through the seams. For example, each seam can include a sealant therein, define a relatively narrow gap, or form a path that is longer than the thickness between the inner wall 116 and the outer wall 118 (e.g., a zigzag path, a curved path, a stepped path, etc.).

The inner wall 116 can at least partially define the internal region 106. In an embodiment, the inner wall 116 can at least partially laterally enclose (e.g., completely enclose) the internal region 106. For example, the inner wall 116 can laterally surround a three-dimensional object, such as the curve of a leg, torso, breast, or blood vessel of a subject. In particular, the inner wall 116 can at least partially enclose a lateral periphery of the internal region 106. For example, the cross-sectional shape of the barrier 104 at the base contact surface 120 can exhibit a generally straight line cross-sectional geometry, a general V-shape cross-sectional geometry, and generally U-shape cross-sectional geometry, a generally semi-circular cross-sectional geometry, a general hollow circular cross-sectional geometry, a generally hollow rectangular cross-sectional geometry, etc. In an embodiment, the internal region 106 can also be partially defined by other structures. For example, the illustrated internal region 106 is defined by the barrier 104, a portion of the printing head 108, and a portion of the region of interest 102.

The outer wall 118 can at least partially define the external region 124. The external region 124 can be any region that is not included in the internal region 106 or occupied by another component of the printing system 100. For example, the external region 124 can at least partially extend from the outer wall 118 away from the internal region 106.

In an embodiment, the external region 124 can include at least one contaminant. The at least one contaminant can include any material, substance, chemical, or physical phenomenon that can decrease the printing system's 100 ability to print an object on the region of interest 102. In an embodiment, the at least one contaminant can include a contaminant that adversely affects the printing quality (e.g., precision) of the printing system 100. In an embodiment, the at least one contaminant can include a contaminant that adversely affects the integrity of the surface of the region of interest 102For example, the at least one contaminant can be one or more dust mites when printing an integrated circuit. In another example, the at least one contaminant can be a liquid (e.g., water, a bodily fluid, etc.). In such an example, the barrier 104 can be configured to keep the surface of the region of interest 102 dry. In an embodiment, the at least one contaminant can include a contaminant that reacts with or damages the printed object or a component of the printing system 100. For example, the at least one contaminant can include an oxidizing agent, a reducing agent, or a corrosive agent. In an embodiment, the at least one contaminant can include a contaminant that can damage the region of interest 102. For example, the at least one contaminant can include bacteria, fungi, viruses, etc., e.g., if the region of interest 102 includes a biological region of interest or includes a nonorganic region of interest requiring a clean field.

The printing system 100 can be positioned such that the base contact surface 120 is positioned at least proximate to a surface 126. The surface 126 can be any surface to which the base contact surface 120 is positioned at least proximate. For example, the surface 126 can include at least a portion of the region of interest 102, a region proximate to the region of interest 102, or a region that at least partially encloses the region of interest 102. In an embodiment, the base contact surface 120 at least partially contacts the surface 126 (e.g., completely contacts the surface 126) when the base contact surface 120 is positioned at least proximate to the surface 126. In an embodiment, gaps or paths can exist between the base contact surface 120 and the surface 126 when the base contact surface 120 at least partially contacts the surface 126.

The printing system 100 can at least partially isolate the internal region 106 from the external region 124 when the base contact surface 120 is positioned at least proximate to the surface 126. At least partially isolating the internal region 106 from the external region 124 also isolates the portions of the region of interest 102 (e.g., entire region of interest 102) from the external region 124. The internal region 106 can be at least partially isolated from the external region 124 when the barrier 104 at least partially prevents the at least one contaminant from entering the internal region 106. For example, the barrier 104 can at least partially isolate the internal region 106 from the external region 124 with regards to only a single selected contaminant, a plurality of selected contaminants, or substantially all contaminants. The internal region 106 can be at least partially isolated from the external region 124 when the barrier 104 at least partially prevents one or more substances (e.g., one or more flushing agents, one or more materials) from leaving or entering the internal region 106. For example, the barrier 104 can at least partially isolate the internal region 106 from the external region 124 with regards to a single selected substance, a plurality of selected substances, or substantially all substances.

In an embodiment, the barrier 104 at least partially prevents at least one material (e.g., the at least one contaminant or the one or more substances) from entering or leaving the internal region 106 when the barrier 104 prevents at least about 50% of at least one material from entering or leaving the internal region 106 than if the barrier 104 was not present, given the same conditions (e.g., pressure or concentration gradient between the internal region 106 and the external region 124). For example, the barrier 104 can be configured to prevent at least about 75%, at least about 90%, at least about 95%, at least about 99%, or at least about 99.9% of the at least one material from entering or leaving the internal region 106 than if the barrier 104 was not there, given the same conditions. The amount of the at least one material that the barrier 104 prevents from entering or leaving the internal region 106 can be selected based on precision of the printing system 100, the size of the printed object, the effect the at least one material has on the printed object, etc. For example, if the printing system 100 is configured to print an integrated circuit, the barrier can prevent at least about 99% of the at least one material (e.g., dust) from entering the internal region 106. In another example, if the printing system 100 is configured to print a simple mechanical device, the barrier 104 may only need to prevent 50% or less of the at least one material from entering the internal region 106.

In an embodiment, the barrier 104 at least partially prevents the at least one contaminant from entering the internal region 106 when the rate at which the at least one contaminant enters the internal region 106 is equal to or less than the rate at which the printing system 100 can remove the at least one contaminant from the internal region 106. For example, the printing system 100 can include one or more removal devices 110. The barrier 104 at least partially prevents at least one contaminant from entering the internal region 106 when a rate at which the at least one contaminant enters the internal region 106 is equal to or less than the rate at which the one or more removal devices 110 removes the at least one contaminant.

In an embodiment, the barrier 104 can be configured to substantially prevent the at least one contaminant entering the internal region 106 from the external region 124. As such, the barrier 104 can be at least semi-impermeable (e.g., substantially impermeable or impermeable) to the at least one contaminant. In an embodiment, the at least one contaminant can include a gas. For example, the at least one contaminant can include oxygen or another oxidizing gas. As such, the barrier 104 can at least partially include or be formed from a material that is at least semi-impermeable to a gas. Materials that are at least semi-impermeable to gases include steel, titanium, rubber, a polymer membrane, or any suitable material. In an embodiment, the at least one contaminant can include a liquid. For example, the at least one contaminant can be a blood or interstitial fluids in an organic environment. As such, the barrier 104 can at least partially include or be formed from a material that is at least semi-impermeable to a liquid. Materials that are at least semi-impermeable to a liquid include a polyaminde, a thin film composite membrane, gore-tex, a polymer membrane, steel, titanium, a silanized aluminum membrane, a ceramic, or any other suitable material. In an embodiment, the at least one contaminant can include a solid, such as dust or organic tissue. As such, the barrier 104 can be formed of a material that is at least semi-impermeable to a solid. For example, the barrier 104 can at least partially include a porous ceramic, a filter, or any other suitable material. In an embodiment, the at least one contaminant can include energy (e.g., heat), electric fields, magnetic fields, electromagnetic radiation (e.g., visible light), or other physical phenomena. As such, the barrier 104 can include a thermally insulating material, an electrically insulating material, a faraday cage, or a material that is at least partially opaque to a certain wavelength, or other suitable materials.

In operation, the barrier 104 can be positioned such that the base contact surface 120 is positioned at least proximate to the surface 126 using various methods. In an embodiment, the barrier 104 can be attached to the printing head 108 and the printing head 108 can be moved to position the base contact surface 120 at least proximate to the surface 126. For example, after the printing head 108 is positioned above the region of interest 102, the printing head 108 can move in the z-direction to position the base contact surface 120 at least proximate to the surface 126. In an embodiment, the barrier 104 can include one or more actuators configured to extend portions of the barrier 104 such that the base contact surface 120 is positioned at least proximate to the surface 126. For example, the barrier 104 can include a hydraulic actuator, a pneumatic actuator, an electroactive actuator, a shape memory actuator, or any suitable actuator. For example, when the printing head 108 is positioned, the one or more actuators of the barrier 104 actuate (e.g., controllably actuate responsive to direction from control electrical circuitry 114) such that the base contact surface 120 is positioned at least proximate to the surface 126. In an embodiment, the printing head 108 can include one or more actuators configured to extend portions of the barrier 104 such that the base contact surface 120 is portioned at least proximate to the surface 126. In an embodiment, one or more components of the printing system (e.g., the barrier 104) can be manually positioned by a user such that the base contact surface 120 is positioned at least proximate to the surface.

In an embodiment, when the base contact surface 120 at least partially contacts the surface 126, the printing system 100 can be configured to increase the pressure between the base contact surface 120 and the surface 126 (e.g., pressure sealing). The increased pressure between the base contact surface 120 and the surface 126 can further prevent the at least one contaminant from entering the internal region 106 by decreasing gaps between the base contact surface 120 and the surface 126. For example, the base contact surface 120 or the surface 126 can deform under the pressure to decrease the gaps therebetween. In an embodiment, the pressure between the base contact surface 120 and the surface 126 can be increased by having the barrier 104 support at least a portion of the weight of the printing system 100 (e.g., the entire weight of the printing system 100). In an embodiment, the support structure 128 can apply a force in the z-direction on the printing head 108 that increases the pressure between the base contact surface 120 and the surface. In an embodiment, the barrier 104 can include one or more actuators that increase the pressure between the base contact surface 120 and the surface.

In an embodiment, the printing system 100 and, in particular, the barrier 104, can be configured to operate in various environments. As such, the barrier 104 can be configured to operate in an environment without losing its ability to isolate the internal region 106 from the external region 124 (e.g., remain at least semi-impermeable to the at least one contaminant). In an embodiment, the printing system 100 can print one or more objects in a biological environment. The biological environment can include an in vivo environment, an ex vivo environment, or an in vitro environment. As such, the barrier 104 can include a biocompatible material (e.g., a biocompatible coating applied thereto). In an embodiment, the printing system 100 can be configured to operate in an oxidizing environment. As such, the barrier 104 can include an oxidation-resistant material or remain at least semi-impermeable to the at least one contaminant when oxidized. In an embodiment, the printing system 100 can be configured to print one or more objects in an environment that includes particles flowing therein. In such an embodiment, the barrier 104 can include a material that is not substantially damaged by the particles flowing thereby.

In an embodiment, the printing system 100 can include a second barrier (not shown) that is used in conjunction with the barrier 104. For example, the second barrier can at least partially enclose or be at least partially enclosed by the barrier 104. In an embodiment, the second barrier can be substantially similar to the barrier 104.

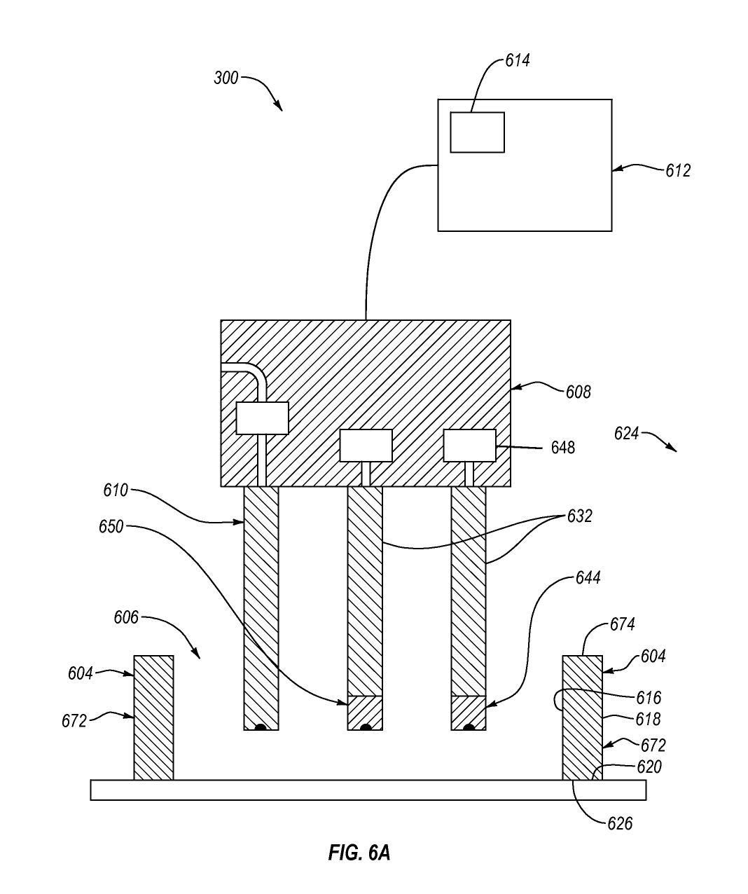

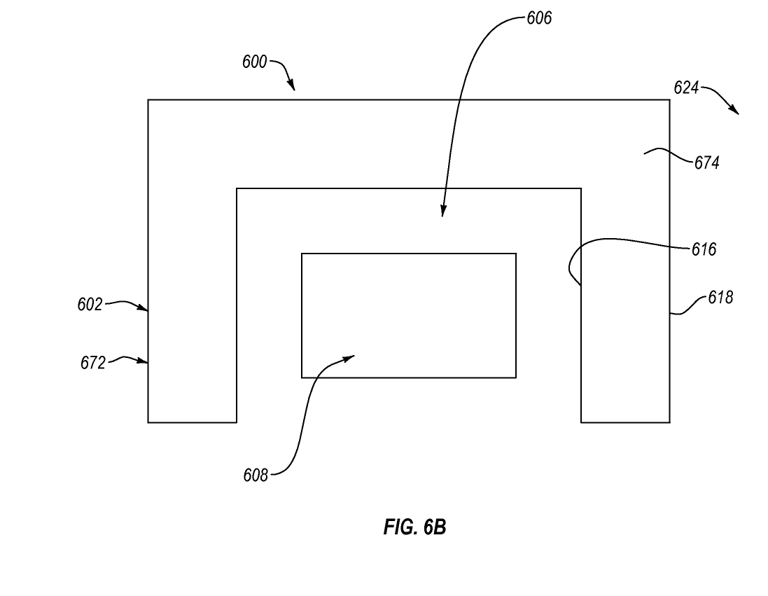

For example, the second barrier can be coupled to and extend from the printing head 108. Alternatively, the second barrier can be freestanding and not coupled to the printing head 108 (e.g., the cofferdam 672 shown in FIG. 6A). Using a second barrier can further isolate the internal region 106 from the external region 124 compared to when only the barrier 104 is used.

In an embodiment, when the internal region 106 is first isolated from the external region 124, the internal region 106 can initially include at least one contaminant therein. In other embodiments, the barrier 104 is not completely impermeable to at least one contaminant, and at least one contaminant can enter the internal region 106. Therefore, the printing system 100 can include one or more removal devices 110 at least partially positioned within or near the internal region 106 configure to remove at least one contaminant.

The one or more removal devices 110 can be any device configured to remove at least one contaminant or substance (e.g., excess flushing agent) from the internal region 106. The one or more removal devices 110 can be at least partially positioned in or near the internal region 106. In the illustrated embodiment, the one or more removal devices 110 are coupled to and extend from the printing head 108. Alternatively, in an embodiment, the one or more removal devices 110 can be attached to, at least partially housed in or integral with the barrier 104. In an embodiment, the one or more removal devices 110 can include at least one removal aperture 130. The at least one removal aperture 130 can be configured to receive at least one contaminant or substance. As such, the at least one removal aperture 130 can be configured to receive a gas, a liquid, or a solid. For example, the at least one removal aperture 130 can include a screen if the at least one removal aperture 130 is configured to only receive a gas or a liquid. In an embodiment, the one or more removal devices 110 can controllably remove at least one contaminant or substance responsive to directions from the control electrical circuitry 114. In an embodiment, the one or more removal devices 110 can remove at least one contaminant or substance without requiring directions from the control electrical circuitry 114. For example, the one or more removal devices 110 can substantially continuously remove at least one contaminant or substance.

In an embodiment, the one or more removal devices 110 can remove one or more substances (e.g., excess flushing agent) from the internal region 106. Removing the one or more substances from the internal region 106 can improve the printing system's 100 control over the printing process or improve the one or more removal devices' 110 ability to remove at least one contaminant from the internal region 106. In an embodiment, the one or more removal devices 110 can be configured to remove selected substances or selected contaminants.

In an embodiment, the one or more removal devices 110 can include one or more sensors 132 coupled thereto (e.g., physically coupled, communicably coupled). In an embodiment, the one or more sensors 132 can detect a presence of at least one contaminant or substance when the internal region 106 is at least partially isolated from the external region 124. The one or more removal devices 110 can be configured to remove the at least one contaminant or substance responsive to a signal from the one or more sensors 132 indicating the presence of the at least one contaminant in the internal region 106. For example, the one or more removal devices 110 can be configured to remove at least a portion of the at least one contaminant or substance from at least a portion of the internal region 106 responsive to a signal from the one or more sensors 132 indicating that a threshold level of the at least one contaminant or substance has been reached in the internal region 106. For example, when a flushing agent is used, the one or more sensors 132 can detect if the flushing agent is present and responsive to a signal from the one or more sensors indicating the presence of the flushing agent, the one or more removal devices 110 can remove the flushing agent (e.g., as it is dispensed) from at least a portion of the internal region 106 to thereby cleanse at least a portion of the region of interest 102. In an embodiment, the one or more sensors 132 can detect when the level of the flushing agent has reached a threshold and, responsive to a signal from the one or more sensors 132 indicating that a threshold level has been reached, the one or more removal devices 110 can remove at least a portion of the flushing agent from at least a portion of the internal region 106. In an embodiment, the one or more sensors 132 can be coupled to the control electrical circuitry 114. The control electrical circuitry 114 can direct the one or more removal devices 110 to remove the at least one contaminant or substance from at least a portions of the internal region 106 responsive to a signal from the one or more sensors 132.

The one or more removal devices 110 and the at least one removal aperture 130 can be positioned at various locations within the internal region 106. In an embodiment, the at least one removal aperture 130 can be positioned near the region of interest 102. In an embodiment, the at least one removal aperture 130 can be positioned near the printing head 108. In an embodiment, the at least one removal aperture 130 can be positioned near one or more weaknesses in the barrier 104. For example, the at least one removal aperture 130 can be positioned near the base contact surface 120. In an embodiment, the at least one removal aperture 130 can be positioned near a seam formed between one or more pieces of the barrier 104.

In an embodiment, the removal device 110 includes one or more microconduits, one or more nozzles, or one or more tubes that are coupled to the at least one removal aperture 130. The one or more microconduits, one or more nozzles, or one or more tubes, can extend from the at least one removal aperture 130 towards the printing head 108. The one or more microconduits, one or more nozzles, or one or more tubes can be configured to have at least one contaminant or substance flow therethrough.

In an embodiment, the one or more removal devices 110 can be configured to remain substantially stationary. For example, the one or more removal devices 110 can include a rigid, semi-rigid, or flexible material. In an embodiment, the one or more removal devices 110 can include one or more actuators that can controllably steer the at least one removal aperture 130. For example, the one or more removal devices 110 can include a rigid material and an actuator attached to the rigid material. The one or more actuators can include a pneumatic actuator, a hydraulic actuator, a piezoelectric actuator, a shape memory material actuator, or an electroactive polymer actuator. For example, each of the one or more removal devices 110 can include a single actuator, an actuator coupled to another actuator, any combinations of actuators, any number of actuators, or an actuator coupled to a portion of the removal device 110 that is not configured to move (e.g., a rigid material). The one or more removal devices 110 can be steerable in one or more directions.

In an embodiment, the one or more removal devices 110 can be configured to be substantially stationary while the printing system 100 is printing an object on the region of interest 102. Maintaining the one or more removal devices 110 substantially stationary can minimize the likelihood that the one or more removal devices 110 shake the printing system 100 during the printing operation, thereby increasing precision of the printing system 100. Alternatively, in an embodiment, the one or more removal devices 110 can be controllably moved while the printing system 100 prints the object.

In an embodiment, the one or more removal devices 110 can controllably steer the at least one removal aperture 130 responsive to direction from the control electrical circuitry 114 (discussed later herein). For example, in an embodiment, the one or more removal devices 110 can include an electroactive polymer actuator. The electroactive polymer can include at least one capacitor applied to a surface thereof. Direction from the control electrical circuitry 114 can cause the capacitor to apply an electric field to the electroactive polymer, thereby causing the electroactive polymer to be controllably actuated. In an embodiment, the one or more removal devices 110 can include a shape memory material actuator. The printing system 100 can include a device configured to apply heat to the shape memory actuator. The device can heat the shape memory material actuator responsive to direction from the control electrical circuitry 114.

In an embodiment, the one or more removal devices 110 can be configured to be controllably steered independently of each other. As such, each of the one or more removal devices 110 can move independently of another removal device 110. For example, each of the one or more removal devices 110 can be configured to receive one or more directions from the control electrical circuitry 114 containing instructions. The instructions can direct each of the one or more removal devices 110 to actuate differently. However, in an embodiment, at least some of the one or more removal devices 110 cannot move independently. For example, two or more removal devices 110 can be rigidly or semi-rigidly attached together or each removal device 110 can receive the same direction from the control electrical circuitry 114.

Additional examples of actuators that can form at least a portion of the removal devices 110 can be found in U.S. patent application Ser. No. 14/664,405 filed on 20 Mar. 2015, the disclosure of which is incorporated herein, in its entirety, by this reference.

The one or more removal devices 110 can be configured to operate in any of various environments. In an embodiment, the printing system 100 prints a biological material in an ex vivo, an in vivo, or an in vitro environment. As such, the one or more removal devices 110 can include a biocompatible material or be configured to operate in a fluid (e.g., blood, interstitial fluids). In an embodiment, the printing system 100 prints a material in an oxidizing environment. As such, the one or more removal devices 110 can include an oxidation-resistant material.

In an embodiment, the one or more removal devices 110 can be coupled to a removal pump 134 configured to controllably remove the at least one contaminant or substance from at least one removal aperture 130. The removal pump 134 can include a least one of a generic pump, a vacuum pump, a compressor, a centrifugal fan, or any device configured to remove at least one contaminant or substance from within or near the internal region 106. For example, a vacuum pump can evacuate or suction a liquid or gas contaminant from a location proximate to the at least one removal aperture 130. In an embodiment, the removal pump 134 can include at least one micropump. A micropump can be a mechanical or non-mechanical micropump. For example, a micropump can be driven by piezoelectric; electrostatic; thermo-pneumatic; pneumatic or magnetic forces; or can utilize electro-hydrodynamic, electro-osmotic, electrochemical or ultrasonic flow generation. In an embodiment, the removal pump 134 can be coupled to a single removal device 110, a plurality of the removal devices 110, or all of the removal devices 110. In an embodiment, the printing system 100 can include a single removal pump 134 or a plurality of removal pumps 134.

In an embodiment, the removal pump 134 can be at least partially positioned within or directly attached to the one or more removal devices 110. In an embodiment, the removal pump 134 can be spaced from the one or more removal devices 110. For example, the removal pump 134 can be at least partially positioned in the printing head 108. In such an embodiment, the one or more removal devices 110 can be coupled to the removal pump 134 via one or more conduits 136. For example, the one or more conduits 136 can extend from the one or more removal devices 110 to the removal pump 134. In an embodiment, the one or more conduits 136 can extend from the removal pump 134 to a location where the removed contaminants are sent or stored. For example, the one or more conduits 136 can extend from the removal pump 134 to an exterior surface of the printing head 108. The exterior surface can include an outlet that is coupled to the one or more conduits 136. In another example, the printing system 100 can include one or more compartments (not shown) configured to store the removed at least one contaminant. As such, the one or more conduits 136 can extend from the removal pump 134 to the one or more compartments.

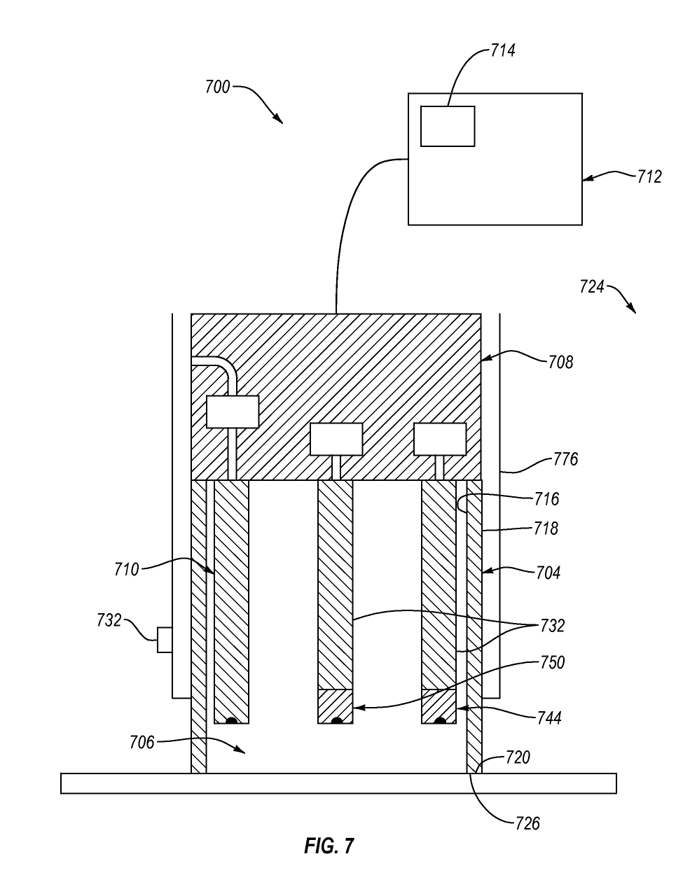

In an embodiment, at least one of the one or more removal devices 110 can be positioned in the external region 124. The at least one removal device 110 positioned in the external region 124 can be configured to remove at least one contaminant from a portion of the external region 124 that is proximate to the barrier 104. Such a configuration can decrease the amount of the at least one contaminant that contacts the barrier 104 and enters the internal region 106. Similarly, the at least one removal device 110 can cause a negative pressure in the external region 124 relative to the internal region 106. The negative pressure in the external region 124 can cause at least one contaminant or substance in the internal region 106 to flow from the internal region 106 to the external region 124. In an embodiment, the printing device 100 can be positioned in a body insertable device (e.g., the body insertable device 776 shown in FIG. 7). In such an embodiment, the at least one removal device 110 positioned in the external region 124 can be a portion of the body insertable device configured to suck up fluids from an internal region of a body of a subject.

As discussed above, the printing system 100 can include the printing head 108, which is configured to support one or more components of the printing system 100. For example, the barrier 104 and the one or more removal devices 110 can be coupled to the printing head 108. The printing head 108 can support the one or more removal devices 110 above, proximate to, adjacent to, or remote from the region of interest 102. The printing head 108 can further include additional components mounted to, supported by, or at least partially enclosed by the printing head 108. For example, the removal pump 134 can be at least partially enclosed by the printing head 108.

The printing system 100 can further include a support structure 128 configured to support the printing head 108 a selected distance from the region of interest 102. For example, the support structure 128 can include one or more beams, columns, stretchers, or other structures coupled to the printing head 108 that maintain the printing head 108 above the region of interest 102. The support structure 128 can be further configured to maintain the printing head 108 substantially stable (i.e. does not uncontrollably tilt or shift) above the region of interest 102. In an embodiment, the support structure 128 can include two or more beams to which the printing head 108 can be attached to or rest on. For example, the support structure 128 can include a first beam 138 that generally extends in the y-direction and a second beam 140 that generally extends in the x-direction. In an embodiment, the support structure 128 can include a single beam to which the printing head 108 can be rigidly attached. In such an embodiment, the printing head 108 can include a clamp, pin, bracket, or other suitable attachment that rigidly attaches the printing head 108 to the support structure 128.

In an embodiment, the printing system 100 can be configured to enable the printing head 108 to move in at least one, at least two, or three dimensions. For example, portions of the support structure 128 can include means for movement, while additional portions of the support structure 128 can include a track on which the potions of the support structure 128 move. Means for movement can include, for example, a motor, gears, gravity, one or more pneumatic actuators, one or more hydraulic actuators, or other means for movement. The means for movement can move the printing head 108 from a first location remote from the region of interest 102 to a second location proximate to the region of interest 102. In an embodiment, the base contact surface 120 can be at least proximate to a surface when the printing head 108 is in the second location. The support structure 128 can move the printing head 108 from the first position to the second position responsive to a signal or direction from the control electrical circuitry 114. The support structure 128 can be configured to move from the first location to the second location without contacting the printing head 108, the barrier 104, or another component of the printing system 100 against an object. For example, the support structure 128 can include one or more sensors 132 that can detect an object and the control electrical circuitry 114 can use the data from the at least one sensor to move the printing head 108 around the object.

The support structure 128 can be configured to move the printing head 108 using a variety of techniques. In an embodiment, portions of the support structure 128 can be configured to rotate about an axis to thereby controllably tilt the printing head 108. For example, when the support structure 128 includes one shaft, the one shaft can rotate or twist, thereby tilting the printing head 108. In an embodiment, when the support structure 128 includes two shafts, one or more of the two shafts can rotate about an axis, thereby tilting the printing head 108. In an embodiment, portions of the support structure 128 can be configured to shift in at least one direction (e.g., at least one of the x-direction, y-direction, or z-direction), thereby displacing the printing head 108. For example, the support structure 128 can include a first beam 138 and a second beam 140 that are generally perpendicular to each other, where the first beam 138 extends in the y-direction and the second beam 140 extends in the x-direction. The first beam 138 can be configured to move in the x-direction and the second beam 140 can be configured to move in the y-direction. The support structure 128 can include tracks that enable the two beams to move in their respective directions. In such an embodiment, the printing head 108 can be attached to the two shafts using two or more bearings (not shown). Such a configuration can permit the printing head 108 to be displaced along the first beam 138 (i.e., the y-direction) when the second beam 140 is moved in the y-direction, and vice-versa. Additionally, the support structure 128 can include an actuator configured to move the tracks in the z-direction, such as a hydraulic actuator. As such, the support structure 128 can move the printing head 108 in the x-direction, y-direction, and z-direction.

In an embodiment, the printing head 108 can be configured to move from the first position to the second position. For example, the printing head 108 can be attached to the support structure 128 using a bearing or other suitable attachment that enables the printing head 108 to move along the support structure 128. Additionally, the printing head 108 can include a motor attached to a wheel, a gear or a drive shaft that controllably moves the printing head 108 along the support structure 128. In an embodiment, both the support structure 128 and the printing head 108 can be configured to move the printing head 108 from the first position to the second position. For example, the support structure 128 can include one or more beams extending in the y-direction that are movable in the x-direction. The printing head 108 can configured to move along the beam in the y-direction.

In an embodiment, the printing system 100 can be configured to maintain the printing head 108 substantially stationary while the printing system 100 prints an object on the region of interest 102. Such an embodiment can improve the stability of the printing system 100. In an embodiment, the printing head 108 can be maintained substantially stationary by the controller 112 by not intentionally directing the printing head 108 or the support structure 128 to move. For example, the printing head 108 can include a motor that is powered off to maintain the printing head 108 substantially stationary. In an embodiment, the printing system 100 can include a device that prevents the printing head 108 from substantially moving during the printing process. The device can include a clamp, pin, or brake that is configured to substantially prevent the printing head 108 or the support structure 128 from moving. The device can be activated by the controller 112 prior to or when the printing system 100 dispenses the one or more materials. In an embodiment, the printing head 108 is configured to move while the printing system 100 prints an object.

In an embodiment, the printing system 100 can include a plurality of printing heads 108. At least some of the plurality of printing heads 108 can be rigidly or semi-rigidly coupled together. For example, the barrier 104 can be attached to each of the plurality of printing heads 108. In an embodiment, at least some of the plurality of printing heads 108 can move independently from each other 106. For example, each of the plurality of printing heads 108 can include a corresponding motor configured to move a corresponding printing head 108. In an embodiment, different portions of the support structure 128 can be attached to each of the plurality of printing heads 108. As such, when each of the different portions of the support structure 128 shifts, twists, or otherwise moves, the attached printing head 108 correspondingly moves. At least some of the plurality of printing heads 108 can be substantially similar or substantially different from each other. Some of the one or more printing heads 108 can be configured to dispense different materials, print different objects substantially simultaneously, print different portions of the object substantially simultaneously, or include different barriers 104 coupled thereto.

In an embodiment, the printing system 100 can further include one or more components that form a printing device configured to print an object on the region of interest 102. The printing device can be configured to print the object in situ. The printing device can be incorporated into the printing head 108, coupled to the printing head 108, or can operate in conjunction with the printing head 108. At least a portion of the printing device can be positioned within the internal region 106. In an embodiment, the printing device can be a specialized device as described herein or other suitable three-dimensional printing device.

In the illustrated embodiment, the printing device includes one or more elongated members 142 coupled to and extending from the printing head 108 towards the region of interest 102. The printing device further includes one or more dispense elements 144 coupled to the one or more elongated members 142. In an embodiment, at least one of one or more elongated members 142 or the one or more dispense elements 144 are at least partially positioned in the internal region 106. The one or more elongated members 142 can include one or more actuators that controllably steer the one or more dispense elements 144. The one or more elongated members 142 can controllably steer the one or more dispense elements 144 proximate to or adjacent to the region of interest 102 and, in particular, a specific segment of the region of interest 102. The one or more dispense elements 144 can include at least one dispense aperture 146 configured to dispense one or more materials onto the region of interest 102. In an embodiment, the base contact surface 120 of the barrier 104 is configured to extend further from the printing head 108 in the z-direction than the at least one dispense aperture 146. The one or more elongated members 142 can be controllably steered and the one or more dispense elements 144 can controllable dispense responsive to direction from the control electrical circuitry 114.

The one or more dispense elements 144 can be coupled to at least one material reservoir 148. The at least one material reservoir 148 can be configured to store the one or more materials that are used to print an object on the region of interest 102. The at least one material reservoir 148 can be located in the one or more dispense elements 144 or located remotely from the one or more dispense elements 144. For example, the at least one material reservoir 148 can be at least partially enclosed by the printing head 108. The at least one material reservoir 148 can be coupled to the one or more dispense elements 144 using one or more conduits 136.

The at least one material reservoir 148 can store any of a variety of or combinations of materials. The at least one material reservoir 148 can store natural or synthetic materials. The at least one material reservoir 148 can store non-organic materials, such as metallic materials, ceramic materials, polymeric materials, other non-organic materials. The at least one material reservoir 148 can store materials for use in forming biocompatible structures, microstructures, nanostructures, scaffolds, nanoscaffolds, or the like. For example, such materials include natural or synthetic polymers, polymer fibers, microfibers, nanofibers, hydrogels, thermo-responsive polymers, Matrigel™ or the like. Non-limiting examples of materials used as scaffolds in tissue engineering are described by Bajaj et al., in Annu Rev Biomed Eng. 2014 Jul. 11; 16: 247-276 (3D Biofabrication Strategies for Tissue Engineering and Regenerative Medicine), which is incorporated herein, in its entirety, by this reference. The at least one material reservoir 148 can store organic or biological materials, such as bioinks, cells, transfected cells, cell products, peptides, proteins, carbohydrates, lipids or tissue. The biological materials can include a biomimetic. The at least one material reservoir 148 can store materials including encapsulation materials in which materials are encapsulated, such as natural or synthetic polymers, phase change polymers, polymersomes, liposomes, or the like. The encapsulating materials can include materials stored or encapsulated therein, such as organic or nonorganic materials, compounds (e.g. medicament), or any biological material.

The biological materials used herein can include materials used to form implants, grafts, or tissues (e.g., vascularized or micro-vasculature tissue). For example, the biological material can include one or more cells including, but are not limited to, stem cells, meschenchymal cells, fibroblasts, adipocytes, pre-adipocytes, hepatocytes, osteocytes, myocytes, cardiomyocytes, smooth muscle cells, endothelial cells, epithelial cells, keratinocytes, primary cells, cultured cells, or the like. For example, the biological material can include one or more proteins including, but are not limited to, collagen, elastin, hyaluronan, fibrin, or laminin; a growth-promoting agent or any growth factor; a cytokine or chemokine; or any immune-related protein. For example, the biological material can include one or more lipids including a phospholipid, sphingolipid, or proteolipid. For example, the biological material can include one or more carbohydrates including any oligosaccharide. The one or more carbohydrates can be associated with one or more peptides, one or more proteins or one or more lipids, such as a proteoglycan, glycoprotein, glycosaminoglycan, glycolipid, or the like. For example, the one or more biomaterials can alone or together arise from, include, or form part or all of an extracellular matrix. For example, the one or more biomaterials can include a tissue, such as a tissue sphere or tissue strand, which can be included in a bioink. The at least one material reservoir 148 can store one or more support materials that facilitate printing the one or more materials onto the region of interest 102. When the one or more materials are biological, the one or more support materials can include an inflammatory suppressant, substances that facilitate the regrowth of tissues (e.g., neurotrophin, adenosine triphosphate, vascular endothelial growth factor, or other growth factors), pain suppressant, suppressors of autoimmune factors, tissue survival promoters (e.g., anti-beta amyloid antibodies when printing neural tissue), or other similar materials. In an embodiment, the one or more support materials can include a binder, a material that supports portions of the printed object and can be removed from the object (e.g., a polymer that is burned off or vaporizes while the object densifies), an emulsifier, or a coating. For example, the at least one material reservoir 148 can store one or more materials used to form capillaries and vascular endothelial growth factor.

Further examples of a printing device including one or more elongated members and one or more dispense elements coupled to the one or more elongated members are disclosed in U.S. patent application Ser. No. 14/664,405 filed on 20 Mar. 2015, the disclosure of which was previously incorporated herein.

In an embodiment, the printing system 100 can include one or more components that form a flushing device configured to dispense one or more flushing agents towards the region of interest 102. The one or more flushing agents configured to prepare the region of interest 102 to have an object printed thereon. The flushing device can be incorporated into the printing head 108, coupled to the printing head 108, or can operate in conjunction with the printing head 108. In an embodiment, the flushing device can be attached to, incorporated into, or at least partially housed in the barrier 104. At least a portion of the flushing device is positioned within the internal region 106. The flushing device can include any known flushing device known in the art.

In the illustrated embodiment, flushing device includes one or more elongated members 142 coupled to and extending from the printing head 108 towards the region of interest 102. The flushing device includes one or more flushing elements 150 coupled to the one or more elongated members 142. In an embodiment, at least one of the one or more elongated members 142 or the one or more flushing elements 150 are at least partially positioned in the internal region 106. The one or more elongated members 142 can include one or more actuators that controllably steer the one or more flushing elements 150. The one or more actuators can include any actuator disclosed herein. The one or more flushing elements 150 can include at least one flushing aperture 152 configured to dispense one or more flushing agents towards the region of interest 102. In an embodiment, the base contact surface 120 of the barrier 104 is configured to extend further from the printing head 108 in the z-direction than the at least one flushing aperture 152. The one or more elongated members 142 can be controllably steered and the one or more flushing elements 150 can controllably dispense responsive to direction from the control electrical circuitry 114.

In an embodiment, the one or more flushing elements 150 can be coupled to at least one flushing agent reservoir 154. The at least one flushing agent reservoir 154 can be configured to store the one or more flushing agents dispensed by the one or more flushing elements 150. The at least one flushing agent reservoir 154 can be located in the one or more flushing elements 150 or located remotely from the one or more flushing elements 150. For example, the at least one flushing agent reservoir 154 can be at least partially enclosed by the printing head 108. The at least one flushing agent reservoir 154 can be coupled to the one or more flushing elements 150 using one or more conduits 136.

The at least one flushing agent reservoir 154 can store any of a variety of or combinations of flushing agents. The one or more flushing agents can include any physical, biological, or chemical agent that at least prepares the region of interest 102 to have an object printed thereon. In an embodiment, the at least one flushing agent reservoir 154 can store one or more cleaning agents configured to remove one or more substances from the region of interest 102. In an embodiment, the at least one flushing agent reservoir 154 can store one or more antimicrobial agents configured to partially or completely destroy microorganisms that are living on the region of interest 102. The one or more antimicrobial agents can include one or more disinfectant agents configured to destroy microorganisms living on a non-living subject, one or more antibiotic agents configured to destroy microorganisms within a living subject, or one or more antiseptic agents configured to destroy microorganisms on living tissue. In an embodiment, the at least one flushing agent reservoir 154 can store one or more sterilizing agents configured to destroy substantially all living tissue on the region of interest 102. In an embodiment, the at least one flushing agent reservoir 154 can store one or more corrosive agents that damage or destroy one or more substances on the region of interest 102 (e.g., oxidizing agents). In an embodiment, the at least one flushing agent reservoir 154 can store one or more inert agents configured to provide an inert atmosphere in the internal region 106. In an embodiment, the at least one flushing agent reservoir 154 can include a flushing gas. The flushing gas can include air, oxygen, carbon dioxide, nitrogen, nitrogen dioxide, or a noble gas. In an embodiment, the at least one flushing agent reservoir 154 can include an external source of a flushing gas. In an embodiment, the flushing device delivers the flushing agent in a laminar flow, for example to maintain sterility of the region of interest 102. In an embodiment, the at least one flushing agent reservoir 154 can store one or more additional flushing agents configured to at least prepare the region of interest 102 to have an object printed thereon.

Further examples of flushing devices including one or more flushing elements are disclosed in U.S. patent application Ser. No. 14/700,743 filed on 30 Apr. 2015, the disclosure of which is incorporated herein, by this reference.

In an embodiment, the printing system 100 can include one or more sensors 132 configured to detect at least one characteristic of the region of interest 102, the printing system 100, the internal region 106, or the external region 124. The at least one characteristic sensed by the one or more sensors 132 can include pressure, temperature, hydration, chemistry, surface contour, boundary conditions, or other features. The at least one characteristic that can be sensed by the one or more sensors 132 can include a position of a component of the printing system 100, such as the proximity of or contact quality between the base contact surface 120 and a surface 126, or the position or movement of the one or more removal devices 110, the rate at which the one or more removal devices 110 remove the at least one contaminant, or the rate at which the barrier 104 allows the at least one contaminant to enter the internal region 106. As such, the one or more sensors 132 can include a pressure sensor configured to sense pressure, a hydration sensor configured to sense moisture, a chemical sensor configured to sense one or more chemical elements or molecules (e.g., an oxygen sensor), a biosensor configured to sense biological matter, an optical sensor, an infrared sensor, other electromagnetic sensors (e.g., radar), a position sensor configured to sense position of one or more components of the printing system 100, an accelerometer configured to sense acceleration of the one or more components of the printing system 100, a flow gauge, an acoustic sensor, a tilt sensor configured to sense tilting of the printing head 108, or any other suitable sensor.

Some sensors can require a stimulus source that emits a stimulus the sensor detects. For example, a chemical sensor mounted to the printing system 100 can include a light source that scatters or excites chemical elements or molecules present in the internal region 106 (e.g., on the region of interest 102) to identify at least one contaminant via spectroscopy.

In an embodiment, the one or more sensors 132 can be attached to different components of the printing system 100. For instance, a sensor 132 can be positioned on the barrier 104 (e.g., on the inner wall 116, the outer wall 118, or the base contact surface 120), the one or more removal devices 110, the printing head 108, the printing device, or the flushing device. The location of the one or more sensors 132 can be configured to not substantially interfere with or influence operation of the barrier 104, the one or more removal devices 110, the printing device, or the flushing device.

As previously discussed, the printing system 100 includes the controller 112, which is communicably coupled, either directly or indirectly, to at least one of the barrier 104, the one or more removal devices 110, the removal pump 134, the printing head 108, the support structure 128, the printing device, the flushing device, or the one or more sensors 132. For example, FIG. 1A illustrates that the controller 112 is communicably coupled directly to the printing head 108 and the components thereof. In an embodiment, the controller 112 can be communicably coupled indirectly to other components of the printing system 100 through the printing head 108. The controller 112 can be communicably coupled through a wired or wireless (e.g., Bluetooth, Wi-Fi) connection. In an embodiment, the controller 112 can be remote from at least one of the barrier 104, the one or more removal devices 110, the printing head 108, the flushing device, or the printing device. In an embodiment, the controller 112 can be at least partially positioned within the barrier 104, the one or more removal devices 110, the printing head 108, the flushing device, or the printing device.

In an embodiment, the controller 112 can include a user interface 156 that enables an individual to communicate with the printing system 100. The user interface 156 can include a display, mouse, keyboard, microphone, speaker, or any other device that enables an individual to communicate with the printing system 100. The user interface 156 can also include software that enables the user to communicate with the printing system 100 such as an operating system, operator controls or a process control. In an embodiment, the user interface 156 can enable an individual to input instructions or commands into the printing system 100. The commands can include instructions to position the base contact surface 120 to be at least proximate to a surface 126, instruction about at least one contaminant, instructions to use one or more removal devices 110 (e.g., the rate at which the one or more removal devices 110 remove the at least one contaminant), information about one or more components of the printing system 100, instructions to execute a program, instructions to cancel an operation, etc. In an embodiment, the printing system 100 can receive and accept the instructions or commands. In an embodiment, the printing system 100 can send data to the user interface 156. The data can include information about the current status of the printing operation, the current status of the printing system 100, an error, or additional information. The user interface 156 can display the data. In an embodiment, the controller 112 can include memory 158 storing operational instructions for operating the printing system 100. The memory 158 can include random access memory (RAM), read only memory (ROM), a hard drive, a disc (e.g., blue-ray, DVD, or compact disc), flash memory, other types of memory electrical circuitry, or other suitable memory. The instructions stored on the memory 158 can include a CAD file representing the three-dimensional object to be printed, a program configured to operate the printing system 100, information about the printing system 100 and the components thereof, information gathered by the printing system 100, or additional information. The controller 112 can further include a processor 160 configured to direct certain operations of the printing system 100 according to the instructions contained in the memory.

As previously discussed, the controller 112 can include the control electrical circuitry 114. The control electrical circuitry 114 controls one or more components of the printing system 100. For example, the control electrical circuity 114 can controllably operate the one or more actuators of the barrier 104, steer the one or more removal devices 110, remove the at least one contaminant using the one or more removal devices, move the printing head 108, operate of the printing device, or operate the flushing device. The control electrical circuitry 114 can control one or more components of the printing system 100 by sending directions to the one or more components. The controller 112 or the control electrical circuitry 114 can communicate the directions to the one or more components of the printing system 100. In an embodiment, the control electrical circuitry 114 can receive data from one or more sensors 132 and can control one or more components of the printing system 100 responsive to the data.

In an embodiment, the control electrical circuitry 114 can be integrally formed with the memory 158 and the processor 160 of the controller 112. Alternatively, the control electrical circuitry 114 can be separate from the memory 158 and the processor 160 of the controller 112. In such an embodiment, the control electrical circuitry 114 can include its own memory and a processor.

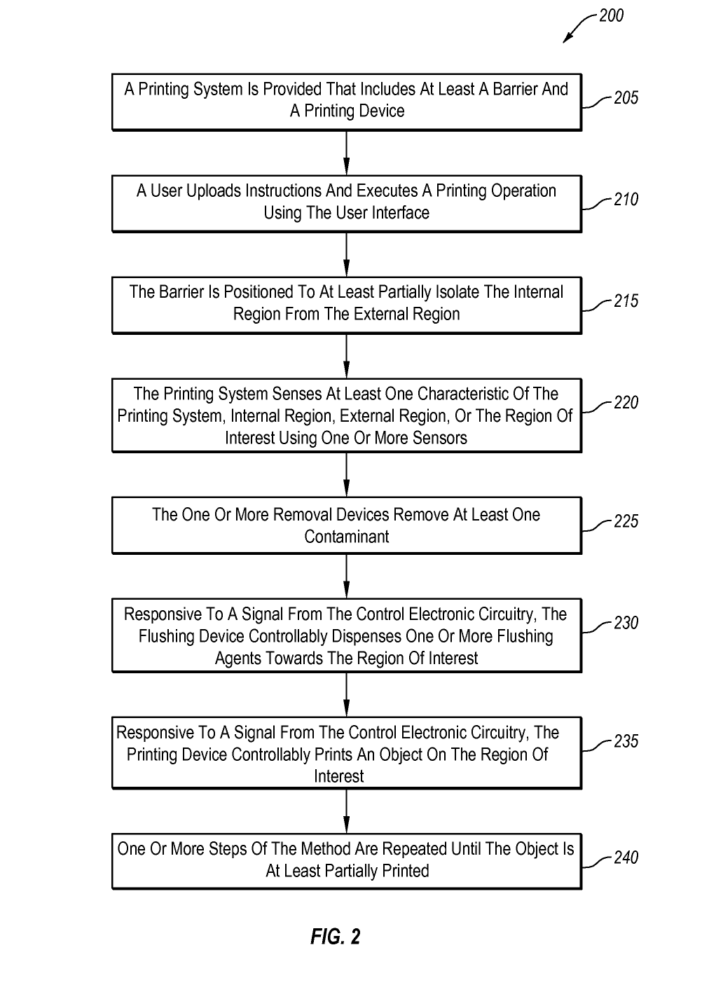

FIG. 2 is a flow diagram of a method 200 of using the printing system 100 shown in FIGS. 1A and 1B, according to an embodiment. The acts of the method 200 can be performed in any order. In some embodiments, some of the acts of the method 200 can be split into a plurality of acts, some of the acts can be combined into a single act, and some acts can be omitted. Also, it is understood that additional acts can be added to the method 200. For example, the additional acts can be required to operate other printing systems disclosed herein.

In act 205, the printing system 100 is provided, which includes at least the barrier 104 and the printing device. The barrier 104 includes the inner wall 116 that at least partially defines an internal region 106 and the outer wall 118 that at least partially defines the external region 124. The printing device can include any suitable printing device configured to print an object onto the region of interest 102. The printing system 100 can further include the one or more removal devices 110, the printing head 108, the support structure 128, the flushing device, the controller 112, or any other components described herein.

In act 210, a user can upload instructions and execute a printing operation using the user interface 156. For example, the user can load instructions into the memory 158 to have the one or more removal devices 110 remove at least one contaminant from the internal region 106. The user can also load, for example, a CAD file of the object to be printed on the region of interest 102. The instructions can be stored in the memory 158. Additionally, the user can instruct the printing system to execute a printing operation. Upon receiving the instructions from the user interface 156, the control electrical circuitry 114 can communicate directions to one or more components of the printing system 100.

In act 215, the barrier 104 is positioned to at least partially isolate the internal region 106 from the external region 124. For example, the base contact surface 120 can be positioned at least proximate to the surface 126. For example, the barrier 104 can be positioned such that at least a portion of the region of interest 102 is at least partially enclosed by the barrier 104. In an embodiment, the user can manually position barrier 104. In an embodiment, the printing system 100 can controllably position the barrier 104. In an embodiment, the barrier 104 can be positioned responsive to direction from the control electrical circuitry 114. In an embodiment, one or more components of the printing system 100 can be positioned in act 215. For example, the printing system 100 can position the one or more dispense elements 144 or the one or more flushing elements 150 proximate to the region of interest 102.

In an embodiment illustrated in act 220, the printing system 100 senses at least one characteristic of the printing system 100, internal region 106, external region 124, or the region of interest 102 using one or more sensors 132. In an embodiment, the one or more sensors 132 can detect the presence of at least one contaminant. For example, the one or more sensors 132 can detect hydration levels in the internal region 106 indicating moisture that needs to be removed therefrom. The one or more sensors 132 can transmit the detected characteristics to the controller 112.

In act 225, the one or more removal devices 110 remove at least one contaminant. For example, in an embodiment, the removal pump 134, coupled to the one or more removal devices 110, evacuates or suctions up at least one contaminant from the internal region 106 and expels the at least one contaminant into the external region 124. In an embodiment, the one or more removal devices 110 can remove at least one contaminant from the internal region 106 responsive to direction from the control electrical circuitry 114. For example, the control electrical circuity 114 can receive detected characteristics of the internal region 106 from the one or more sensors 132 and can control the one or more removal devices 110 responsive to the received data. In an embodiment, the one or more removal devices 110 can also remove one or more substances from the internal region 106.

In act 230, responsive to a signal from the control electrical circuitry 114, the flushing device can controllably dispense one or more flushing agents towards the region of interest 102. In an embodiment, the control electrical circuitry 114 can controllably steer the one or more flushing elements 150 using the one or more elongated members 142. For example, the one or more elongated members 142 can position the one or more flushing elements 150 adjacent to or proximate to a specific segment of the region of interest 102 responsive to direction from the control electrical circuitry 114. Similarly, the control electrical circuitry 114 can controllably direct the flushing device to dispense one or more flushing agents through at least one flushing aperture 152 of the one or more flushing elements 150 towards the region of interest 102. For example, the control electrical circuitry 114 can communicate a direction instructing at least one of the one or more flushing elements 150, the at least one flushing agent reservoir 154, or the one or more conduits 136 to dispense the one or more flushing agents.

In act 235, responsive to a signal from the control electrical circuity 114, the printing device can controllably print an object on the region of interest 102. Act 235 can be performed before act 230, substantially simultaneously with act 230, after act 230, or combinations thereof. In an embodiment, the control electrical circuitry 114 can controllably actuate the one or more dispense elements 144 using the one or more elongated members 142. The one or more elongated members 142 can position the one or more dispense elements 144 adjacent to or proximate to a specific segment of the region of interest 102. Similarly, the control electrical circuitry 114 can controllably direct the printing device to dispense one or more materials through at least one dispense aperture 146 of the one or more dispense elements 144 onto the region of interest 102. For example, the control electrical circuitry 114 can communicate the signal or direction instructing at least one of the one or more dispense elements 144, the at least one material reservoir 148, or the one or more conduits 136 to dispense the one or more materials.

In act 240, one or more acts of the method 200 are repeated until the object is at least partially printed. In an embodiment, merely act 235 is repeated until the object is completely printed. In an embodiment, two or more acts of the method 200 are repeated until the object is at least partially printed. For example, act 215 can be repeated if the object to be printed is larger than the internal region 106.

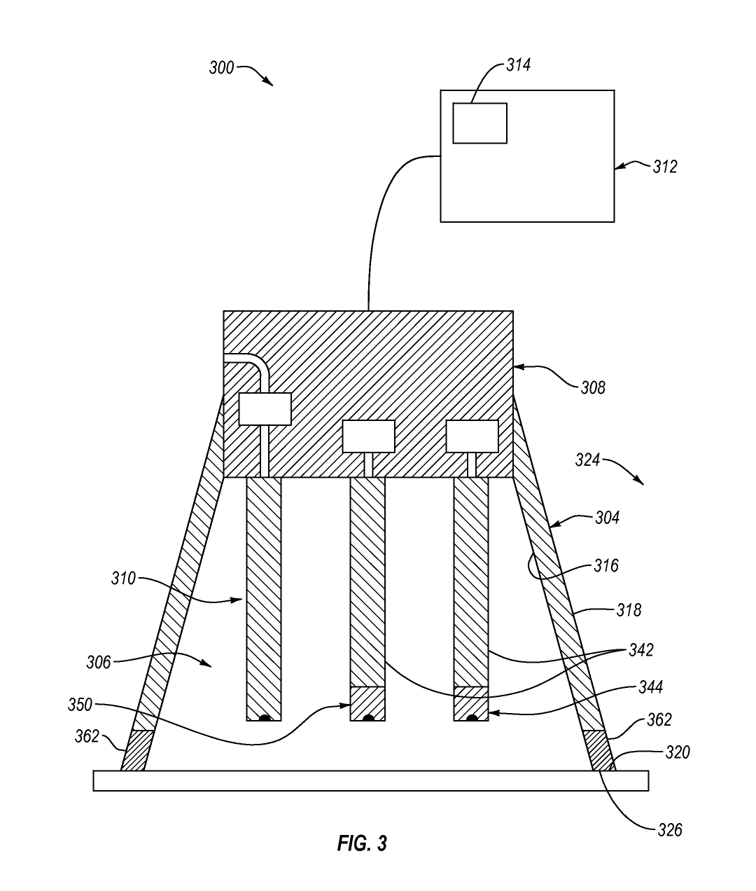

FIG. 3 is a schematic cross-sectional view of a printing system 300, according to an embodiment. The printing system 300 includes a barrier 304 having a seal 362. The printing system 300 can utilize any of the printing system embodiments illustrated and described in connection with the printing systems shown in FIGS. 1, 4, 5, 6A, and 7.

The printing system 300 can be substantially similar to the printing system 100 shown in FIGS. 1A and 1B. For example, the barrier 304 can be coupled to the printing head 308. The barrier 304 includes an inner wall 316 that at least partially defines an internal region 306, an outer wall 318 that at least partially defines an external region 324, and a base contact surface 320. The printing system 300 can include one or more removal devices 310 configured to remove at least one contaminant from the internal region 306. The printing system 300 can include a printing device (e.g., one or more elongated members 342 coupled to one or more dispense elements 344) or a flushing device (e.g., one or more elongated members 342 coupled to one or more flushing elements 350). Additionally, the printing system 300 can include a controller 312. The controller 312 can include control electrical circuitry 314 that controls one or more components of the printing system 300.

In an embodiment, the base contact surface 320 of the barrier 304 can include a seal 362 configured to contact a surface 326. The seal 362 can seal the barrier 304 to the surface 326, thereby at least partially preventing at least one contaminant from entering the internal region 106 from the external region 324 or at least one substance from exiting the internal region 106 to the external region 324. For example, the seal 362 can be configured to at least minimize (e.g., substantially eliminate, substantially fill) gaps between the base contact surface 320 and the surface 326 compared to a barrier 304 without the seal 362, when the same pressure exists between the base contact surface 320 and the surface 326. Minimizing gaps between the base contact surface 320 and the surface 326 can reduce or eliminate paths through which at least one contaminant or substance can flow. The seal 362 can be configured to be at least semi-impermeable (e.g., substantially impermeable) to that at least one contaminant or substance. As such, the seal 362 can enable the barrier 304 to at least partially isolate the internal region 106 from the external region 124. In an embodiment, the seal 362 defines the base contact surface 320 and can extend a distance from the base contact surface 320 towards the printing head 308. For example, the base contact surface 320 defined by the seal 362 can at least partially deform when pressed against the surface 326, thereby minimizing gaps between the base contact surface 320 and the surface 326. Alternatively, the seal 362 can include a coating or adhesive applied to a surface of the barrier 304 to form the base contact surface 320.

The seal 362 can include a variety of different types of seals and be formed from a variety of materials. In an embodiment, the base contact surface 320 can include a seal 362 that includes a compressible material that, when compressed, at least minimizes the gaps between the base contact surface 320 and the surface 326. The compressible material can include rubber, soft metals (e.g., gold), silicone, cork, or similar materials. In an embodiment, the base contact surface 320 can include a seal 362 that includes an adhesive sealant. An adhesive sealant can at least partially fill the gaps between the base contact surface 320 and a surface. Additionally, in some embodiments, the adhesive sealant can bond, attach, or adhere the base contact surface 320 to the surface 326. Examples of adhesive sealants include silicone, resins, rubber, epoxy, glue, foam, wax, polyurethane, tar, clay, grease, etc. In an embodiment, the base contact surface 320 can include a seal 362 that includes a gasket. The gasket can include a material that exhibits some degree of deformation when a pressure is applied thereto. In an embodiment, the base contact surface 320 can include a seal 362 that includes a ferrofluidic seal. The ferrofluidic seal includes a ferrofluid that at least minimizes the gaps between the base contact surface 320 and the surface 324. In such an embodiment, the barrier 304 can include a magnet or magnetic field-inducing system operated by the controller 312 that controls the ferrofluid. In an embodiment, the base contact surface 320 can include a plurality of seals 362. For example, the base contact surface 320 can include a gasket and a compressible material attached to the gasket. In an embodiment, the seal 362 can include any suitable material or device that can reduce the gap between the base contact surface 320 and the surface 326.

In an embodiment, the seal 362 can be configured to be weak (e.g., fail when certain stresses are applied thereto, such as shear stresses) or strong (e.g., resistant to failure when one or more stresses are applied thereto). In an embodiment, the seal 362 can be controllably reversibly weak or strong. In an embodiment, the seal 362 can cause the printing system 300 to permanently bond to or temporarily bond to the surface 326. In an embodiment, the seal 362 can provide thermal, electrical, magnetic, or acoustic insulation. In an embodiment, the seal 362 can be configured to operate in a variety of environments, while maintaining the seal's 362 properties. For example, the seal 362 can be configure to operate in a biological environment (e.g., an in vivo, an in vitro, or an ex vivo environment), an oxidizing environment, a heated environment, or other environments.

In an embodiment, the printing system 300 is configured to apply a force on the barrier 304 that increases the pressure between the base contact surface 320 and a surface 326. The increased pressure can cause the seal 362 to at least partially fill (e.g., substantially fill) the gaps between the base contact surface 320 and the surface 326. For example, the barrier 304 can include one or more actuators. Responsive to direction from the control electrical circuitry 314, the one or more actuators can actuate causing the base contact surface 320 to press against the surface 326.

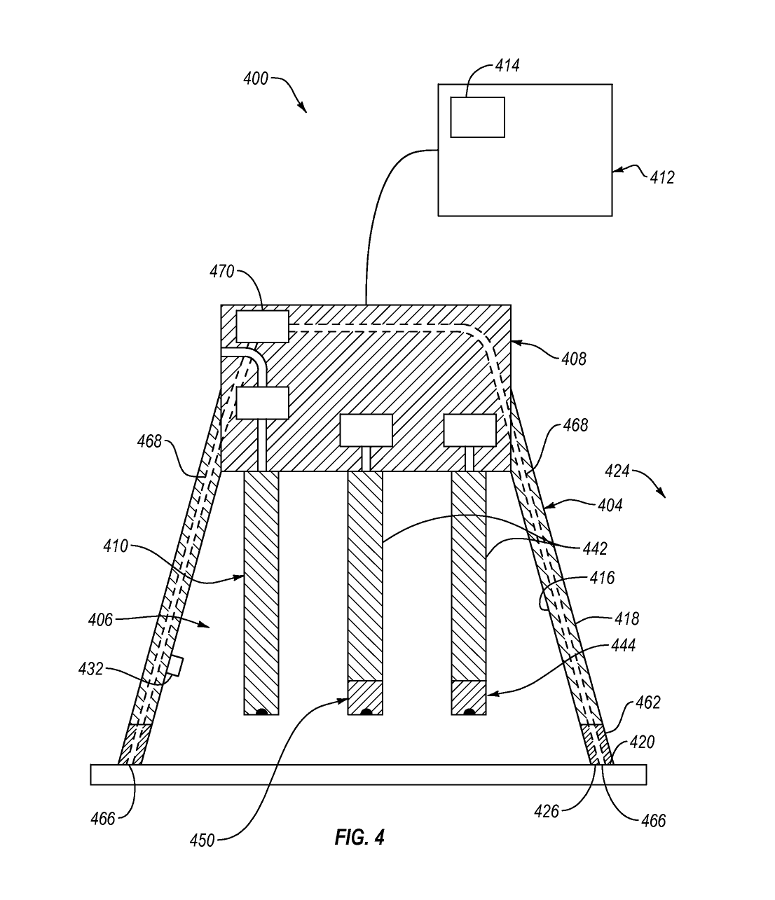

FIG. 4 is a schematic cross-sectional view of a printing system 400, according to an embodiment. The printing system 400 includes a vacuum device configured to suction a barrier 404 to a surface 426. The printing system 400 can utilize any of the printing system embodiments illustrated and described in connection with the printing systems shown in FIGS. 1, 3, 5, 6A, and 7.

The printing system 400 can be substantially similar to the printing system 300 shown in FIG. 3. For example, the barrier 404 can be coupled to the printing head 408. The barrier 404 can include an inner wall 416 that at least partially defines an internal region 406, an outer wall 418 that at least partially defines an external region 424, and a base contact surface 420. The barrier 404 can also include a seal 462. The printing system 400 can include one or more removal devices 410 configured to at least remove at least one contaminant from the internal region 406. The printing system 400 can include a printing device (e.g., one or more elongated members 442 coupled to one or more dispense elements 444) or a flushing device (e.g., one or more elongated members 442 coupled to one or more flushing elements 450). Additionally, the printing system 400 can include a controller 412. The controller 412 can include control electrical circuitry 414 that can control one or more components of the printing system 400.

The printing system 400 includes a vacuum device configured to suction the barrier 404 to a surface 426. As such, the vacuum device can seal the barrier 404 to the surface 426, for example, using the seal 462. In an embodiment, the vacuum device includes one or more holes 466 formed in the base contact surface 420 of the barrier 404. The vacuum device also includes one or more tubes 468 (shown with phantom lines) extending from the one or more holes 466 through at least a portion of the barrier 404. The vacuum device further includes at least one vacuum 470 coupled to the one or more tubes 468 and configured to induce a negative pressure at a region proximate to the one or more holes 466. Providing negative pressure to a region proximate to the one or more holes 466 can cause the base contact surface 420 to press against the surface 426, thereby suctioning the barrier 404 to the surface 426. The vacuum device can operate responsive to direction from the control electrical circuitry 414.

The barrier 404 can include one or more holes 466 formed therein. One or more holes 466 can be formed in the base contact surface 420. In an embodiment, the one or more holes 466 can include a plurality of holes 466. Each of the plurality of holes 466 can be spaced from immediately adjacent holes 466. For example, each of the plurality of holes 466 can be radially spaced or circumferentially spaced from immediately adjacent holes 466. In an embodiment, the barrier 404 can include a single hole 466 formed therein. For example, the barrier 404 can include a hole 466 that extends through the entire length or path of the base contact surface 420.

In an embodiment, the one or more holes 466 can include a nozzle, an aperture, or other type of opening configured to receive a fluid. For example, at least one of the one or more holes 466 can be configured to at least receive at least one contaminant. In such an example, the one or more holes 466 can act as a removal device. Additionally, the one or more holes 466 can also receive one or more substances.

The one or more holes 466 can include one or more tubes 468 extending therefrom towards the at least one vacuum 470. As such, the one or more tubes 468 can communicably couple the one or more holes 466 to the at least one vacuum 470.

In an embodiment, at least one tube 468 can be configured to merge with an adjacent tube 468 to form a single tube 468 at some point between the one or more holes 466 and the vacuum 470. In an embodiment, a single tube 468 can separate into two separate tubes 468. For example, the vacuum device can include a single hole 466 coupled to two or more vacuums 470. A single tube 468 can extend from the single hole 466. At some point between the single hole 466 and the two or more vacuums 470, the single tube 468 can separate into two or more tubes 468 thereby coupling the single hole 466 to the two or more vacuums 470.

In an embodiment, the at least one vacuum 470 can include any device configured to provide negative pressure at a location proximate to the one or more holes 466. In an embodiment, the at least one vacuum 470 can include any device configured to evacuate or suction a fluid or small solids from a location proximate to the one or more holes 466. For example, the at least one vacuum 470 can include a pump, a vacuum pump, a compressor, a centrifugal fan, or other suitable device. In an embodiment, the vacuum 470 can be configured to expel the fluid received from the one or more holes 466 into the external region 424. In an embodiment, the vacuum 470 can controllably suction the fluid from a location proximate to the one or more holes 466 responsive to direction from the control electrical circuitry 414. In an embodiment, the vacuum 470 can substantially continuously or intermittently provide negative pressure and/or evacuate or suction the fluid without direction from the control electrical circuitry 414. In an embodiment, the vacuum 470 can provide negative pressure or suction the fluid responsive to a characteristic detected by one or more sensors 432 (e.g., proximity of the base contact surface 420 to the surface 426).

The at least one vacuum 470 can be positioned in various locations of the printing system 400. In an embodiment, the at least one vacuum 470 can be positioned in the barrier 404. In such an embodiment, the one or more tubes 468 do not need to extend completely through the barrier 404. In an embodiment, the at least one vacuum 470 can be positioned in the printing head 408. In an embodiment, the at least one vacuum 470 can be only partially positioned in the printing head 408 (e.g., only partially enclosed by the printing head 408). In an embodiment, the at least one vacuum 470 can be located remote from the printing head 408 and the barrier 404. In such an embodiment, the one or more tubes 468 can extend from the barrier 404 or the printing head 408 to the location of the at least one vacuum 470.

In an embodiment, the vacuum 470 can be configured to induce positive pressure or to blow a fluid (e.g., air) towards the one or more holes 466. For example, evacuating or suctioning a fluid from a location proximate to the one or more holes 466 can temporarily bond the barrier 404 to the surface 426 via suction. Blowing a fluid towards or through the one or more holes 466 can break the bond between the barrier 404 and the surface 426. In another example, blowing a fluid towards or through the one or more holes 466 can cause a first portion of the fluid exiting the one or more holes 466 to flow from the one or more holes 466 towards the internal region 406 and a second portion of the fluid exiting the one or more holes 466 to flow from the one or more holes 466 towards the external region 424 or towards the one or more tubes 468. The second portion of the fluid can, in some embodiments, at least partially prevent at least one contaminant from entering the internal region 406 from the external region 424. In an embodiment, a fluid flow through the one or more holes 466 can form a laminar fluid flow.

In an embodiment, the one or more removal devices 410 positioned in the internal region 406 can cause the barrier 404 to be suctioned to a surface 426. For example, the one or more removal device 410 can remove at least one fluid from the internal region 406. Removing the at least one fluid from the internal region 406 can cause the pressure in the internal region 406 to be less than the pressure in the external region 424. The lower pressure in the internal region 406 can cause the barrier 404 to be suctioned to the surface 426 which can cause the base contact surface 420 to be pressed against the surface 426.

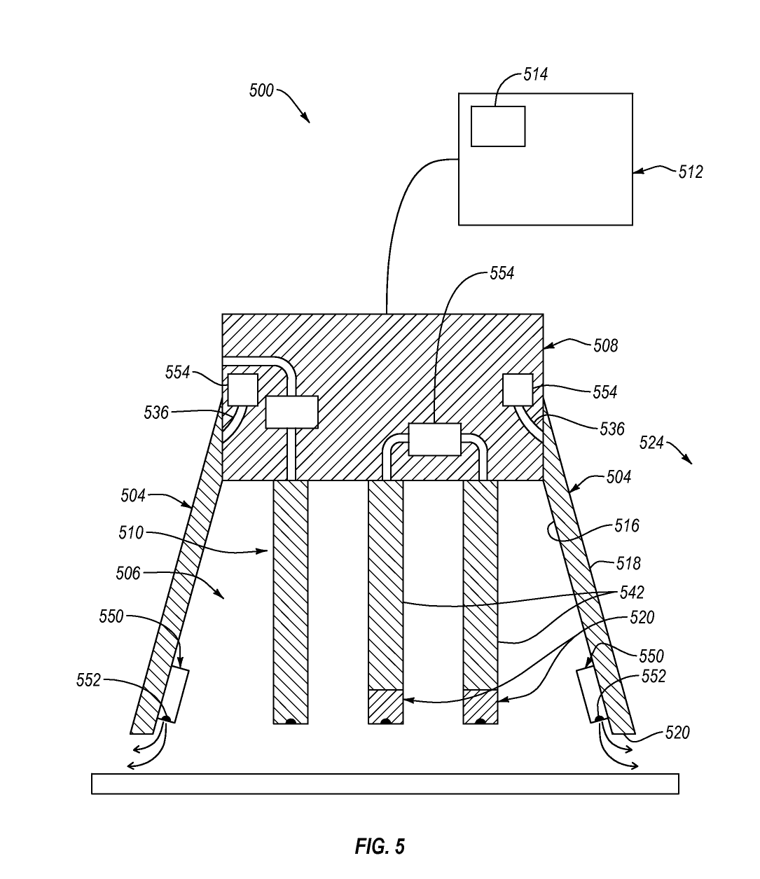

FIG. 5 is a schematic cross-sectional view of a printing system 500, according to an embodiment. The printing system 500 includes one or more flushing elements 550 configured to cause the pressure in the internal region 506 to be greater than the external region 524. The printing system 500 can utilize any of the printing system embodiments illustrated and described in connection with the printing systems shown in FIGS. 1, 3, 4, 6A, and 7.

The printing system 500 can be substantially similar to the printing system 100 shown in FIG. 1. For example, the printing system 500 can include a barrier 504 coupled to the printing head 508. The barrier 504 can include an inner wall 516 that at least partially defines an internal region 506, an outer wall 518 that at least partially defines an external region 524, and a base contact surface 520. The printing system 500 can include one or more removal devices 510 configured to remove at least one contaminant from the internal region 506. The printing system 500 can include a printing device including one or more elongated members 542 coupled to one or more dispense elements 544. The printing device include a single material reservoir 548 fluidly coupled to each of the one or more dispense elements 544. The printing system 500 can include a controller 512. The controller 512 can include control electrical circuitry 514 that can control one or more components of the printing system 500.

The printing system 500 can include one or more flushing elements 550 configured to dispense one or more flushing agents into the internal region 506. The one or more flushing elements 550 include at least one flushing aperture 552. In an embodiment, the one or more flushing elements 550 can dispense the one or more flushing agents into the internal region 506 at a rate greater than the one or more removal devices 510 remove at least one fluid (e.g., at least one contaminant). As such, the one or more flushing elements 550 can generate a pressure in the internal region 506 to be higher than the pressure in the external region 524. The higher pressure in the internal region 506 can cause a fluid (e.g., the one or more flushing agents) to exit the internal region 506 and enter the external region 524. For example, the fluid can flow through gaps between the base contact surface 520 and a surface 526, seams in the barrier 504, etc. The fluid exiting the internal region 506 can at least partially occupy paths that at least one contaminant uses to enter the internal region 506. As such, the higher pressure in the internal region 506 caused by the one or more flushing elements 550 can at least partially prevent at least one contaminant from entering the internal region 506. In an embodiment, the one or more flushing elements 550 can controllably dispense the one or more flushing elements 550 responsive to direction from the control electrical circuitry 514.

In an embodiment, the one or more flushing elements 550 can dispense the one or more flushing agents into the internal region 506 at a rate substantially equal to the rate at which the one or more removal devices 510 remove at least the one or more flushing agents. For example, in such an embodiment, the printing system 500 can cleanse a region of interest. For example, in such an embodiment, the printing system 500 can maintain a sterile environment (e.g., by maintaining a laminar flow).

The one or more flushing elements 550 can be placed at various locations within the internal region 506. In an embodiment, the one or more flushing elements 550 can be coupled to one or more elongated members, with the one or more elongated members coupled to and extending from the printing head 508 (e.g., the flushing elements 150 illustrated in FIG. 1A). In the illustrated embodiment, the one or more flushing elements 550 are coupled to the barrier 504. In such an embodiment, the barrier 504 can be at least partially hollow and fluidly couple the one or more flushing elements 550 to one or more conduits 536. In an embodiment, the one or more conduits 536 can extend from the barrier 504 to at least one flushing agent reservoir 554 positioned in the printing head 508. Alternatively, In an embodiment, the at least one flushing agent reservoir 554 can be at least partially positioned in the barrier 504, at least partially positioned in the one or more flushing elements 550, or can be positioned in another location of the printing system 500. The one or more flushing elements 550 can be configured to dispense the one or more flushing agents towards the base contact surface 520. Positioning the one or more flushing elements 550 on the barrier 504 can reduce the amount of the one or more flushing agents flowing proximate to the one or more dispense elements 544, thereby improving the precision of the printing system 500. In an embodiment, the one or more flushing elements 550 can be at least partially enclosed by or incorporated into the barrier 504. For example, similar to the vacuum device shown in FIG. 4, the one or more flushing elements 550 can be at least partially incorporated into the barrier 504 and configured to dispense the one or more flushing agents from the base contact surface 520.

FIGS. 6A and 6B are a schematic cross-sectional view and top view of a printing system 600, respectively, according to an embodiment. The printing system 600 includes a barrier 604 that is configured as a cofferdam 672. The printing system 600 can utilize any of the printing system embodiments illustrated and described in connection with the printing systems shown in FIGS. 1, 3, 4, 5, and 7.

The printing system 600 can be substantially similar to the printing system 100 shown in FIG. 1A. For example, the printing system 600 can include one or more removal devices 610 configured to remove at least one contaminant from the internal region 606. The printing system 600 can further include a printing device (e.g., one or more elongated members 642 coupled to one or more dispense elements 644) and a flushing device (e.g., one or more elongated members 642 coupled to one or more flushing elements 650). Additionally, the printing system 600 can include a controller 612. The controller 612 can include control electrical circuitry 614 that controls one or more components of the printing system 600.

As discussed above, in an embodiment, the barrier 604 can be in the form of a cofferdam 672. The cofferdam 672 includes an inner wall 616 and an outer wall 618 that is spaced from the inner wall 616. The inner wall 616 can at least partially define the internal region 606 and the outer wall 618 can at least partially define the external region 624. The cofferdam 672 can also include a base contact surface 620 that extends between the inner wall 616 and the outer wall 618. The base contact surface 620 is configured to be positioned at least proximate to a surface 626. The cofferdam 672 also includes an upper surface 674 that is spaced from the base contact surface 620. The upper surface 674 also extends between the inner wall 616 and the outer wall 618. In an embodiment, at least a portion of the upper surface 674 is not coupled to or does not extend from the printing head 608. As such, a gap exists between at least a portion of the upper surface 674 and the printing head 608.

In an embodiment, the cofferdam 672 does not include at least one of the base contact surface 620 or the upper surface 674. For example, the cofferdam 672 can include an inner wall 616 and an outer wall 618 that extend from the base contact surface 620 and intersect with each other. In an embodiment, the cofferdam 672 can only include an inner wall 616 and an outer wall 618 that form a generally circular cross-sectional geometry. In both examples, a gap can exist between the cofferdam 672 and the printing head 608.

In an embodiment, the cofferdam 672 can be configured to completely enclose a lateral periphery of the internal region 606. For example, the cofferdam 672 can exhibit a generally hollow triangular cross-sectional geometry, a generally hollow rectangular cross-sectional geometry, a generally hollow circular cross-sectional geometry, or any suitable cross-sectional geometry. However, in the embodiment illustrated in FIG. 6B, the cofferdam 672 can be configured to partially enclose the lateral periphery of the internal region 606. For example, the cofferdam 672 can have a cross-sectional geometry that exhibits a generally linear cross-sectional geometry, a generally v-shaped cross-sectional geometry, a generally u-shaped cross-sectional geometry, a generally semicircular cross-sectional geometry, or any suitable cross-sectional geometry. In an embodiment, the cofferdam 672 can exhibit geometry that substantially conforms to the geometry of another component of the printing system. For example, as illustrated in FIG. 6B, the cofferdam 672 exhibits a block u-shaped geometry that is similar to the rectangular geometry of the periphery of the printing head 608.

In an embodiment, the cofferdam 672 is configured to be manually positioned by a user or the printing system 600. For example, when the cofferdam 672 is freestanding (e.g. not attached to the printing head 608 or another component of the printing system 600), the printing system 600 can move the cofferdam 672 from a first location to a second location by pushing the cofferdam 672 using one or more components of the printing system 600. In an embodiment, the cofferdam 672 can include one or more structures (not shown) extending from the cofferdam 672 to at least one component of the printing system 600 (e.g., the printing head 608, the support structure, etc.). The one or more structures can physically couple the cofferdam 672 to a component of the printing system 600 and can enable the printing system 600 to move the cofferdam 672. However, the one or more structures may not completely eliminate the gap between the cofferdam 672 and the printing head 608.

In an embodiment, the cofferdam 672 can include one or more components of the printing system 600 attached thereto, incorporated therein, or at least partially housed therein. For example, the cofferdam 672 can include one or more components of the printing device, such as the one or more elongated members 642 coupled to the one or more dispense elements 644. In such an example, the printing system 600 can include one or more tubes (not shown) extending between the cofferdam 672 and the printing head 608 that fluidly couples the one or more dispense elements 644 to at least one material reservoir 648. Similarly, the cofferdam 672 and the one or more components of the printing device can be communicably coupled to the control electrical circuitry 614. In an embodiment, the cofferdam 672 can include the entire printing device such that the cofferdam 672 does not need to be coupled to the printing head 608. In an embodiment, the cofferdam 672 can include one or more components of the flushing device (e.g., the entire flushing device), one or more components of a removal device (e.g., the entire removal device, not shown), or one or more components of a vacuum device (e.g., the entire vacuum device, not shown). In another embodiment, the cofferdam 672 or the printing head 608 can include one or more actuators that enable the cofferdam 672 to be controllably steered relative to the printing head 608.

FIG. 7 is a schematic cross-sectional view of a printing system 700 configured to be inserted into an internal region of a body of a subject (e.g. during laparoscopic surgery), according to an embodiment. The printing system 700 can utilize any of the printing system embodiments illustrated and described in connection with the printing systems shown in FIGS. 1, 3, 4, 5A, and 6.

The printing system 700 can be substantially similar to the printing system 100 shown in FIG. 1. For example, the printing system 700 includes a barrier 704 coupled to the printing head 708. The barrier 704 includes an inner wall 716 that at least partially defines an internal region 706, an outer wall 718 that at least partially defines an external region 724, and a base contact surface 720. The printing system 700 can include one or more removal devices 710 configured to remove at least one contaminant from the internal region 706. The printing system 700 can include a printing device (e.g., one or more elongated members 742 coupled to one or more dispense elements 744) or a flushing device (e.g., one or more elongated members 742 coupled to one or more flushing elements 750). Additionally, the printing system 700 can include a controller 712. The controller 712 can include control electrical circuitry 714 that controls one or more components of the printing system 700.

Referring to FIG. 7, the printing system 700 can be configured to be partially inserted into an internal region of interest 702 of a living subject (e.g. an animal, a person). The internal region of interest 702 of a living subject can include any region that is integral to a biological body. For example, the internal region of interest 702 of a human body can include a region that is epidermal, endodermal, subdermal, subcutaneous, intraperitoneal, intra-abdominal, intra-organ, intracranial, skeletal, muscular, nervous, cardiac, luminal, endoluminal, etc. In such an embodiment, the printing head 708 can remain outside the subject while the one or more elongated members 742 can be configured to be inserted into the internal region of interest 702 (e.g., an epidermal region, an endodermal region, a subdermal region, a subcutaneous region, an intraperitoneal region, an intra-abdominal region, an intra-organ region, an intracranial region, a skeletal region, a muscular region, a nervous region, a cardiac region, a visceral region, a parietal region, a lumenal region, an endolumenal region, etc.). For example, during laparoscopic surgery, the printing head 708 can be positioned adjacent to an opening of a trocar or a cannula. The trocar or cannula can be partially inserted into the living subject. The barrier 704, the one or more removal devices 710, or one or more components of the printing system 700 (e.g., the one or more removal devices 710, the one or more elongated members 742, the one or more dispense elements 744, the one or more flushing elements 750, etc.) can be at least partially inserted into the subject using the trocar or cannula.

The printing system 700 can include a body-insertable device 776 configured to insert the barrier 704, the one or more removal devices 710, or one or more components of the printing system 700 into the subject and access the internal region of interest 702. In an embodiment, the body-insertable device 776 can include a catheter, endoscope, or other suitable devices. For example, the body-insertable device 776 can include an endoscope that includes at least one channel configured to at least partially house at least one of the one or more removal devices 710, the one or more elongated members 742, the one or more flushing elements 750, or the one or more dispense elements 744. In an embodiment, the at least one channel can also be configured to at least partially house the barrier 704. In an embodiment, the barrier 704 can be at least partially housed in at least one additional channel where the at least one additional channel is adjacent to or remote from the at least one channel. In an embodiment, the barrier 704 can be positioned around at least one channel such that the barrier 704 at least partially encloses the at least one barrier 704.

In an embodiment, the body-insertable device 776 can be configured to protect or guide the barrier 704, the one or more removal devices 710, or one or more components of the printing system 700, while the barrier 704, the one or more removal devices 710, or one or more components of the printing system 700 are inserted into the subject. As such, the body-insertable device 776 can at least partially house the barrier 704, the one or more removal devices 710, or one or more components of the printing system 700. For example, in an embodiment, the portions of the barrier 704, the one or more removal devices 710, or one or more components of the printing system 700 can protrude from the body-insertable device 776. Alternatively, in an embodiment the barrier 704, the one or more removal devices 710, or one or more components of the printing system 700 can be configured to be completely housed in the body-insertable device 776 while being inserted into the subject. However, when the body-insertable device 776 is proximate to the internal region of interest 702, the one or more actuators (e.g., the one or more actuators of the barrier 704, the one or more removal devices 710, or the one or more elongated members 742) can actuate such that portions of the barrier 704, the one or more removal devices 710, or one or more components of the printing system 700 protrude from the body-insertable device 776. In an embodiment, the body-insertable device 776 can be attached to the printing head 708 or the barrier 704. Alternatively, in an embodiment, the body-insertable device 776 can only house a portion of the barrier 704, the one or more removal devices 710, or one or more components of the printing system 700.

In an embodiment, the printing system 700 can be configured to operate during laparoscopic surgery. For example, the body-insertable device 776 can at least partially house the barrier 704, the one or more removal devices 710, or one or more components of the printing system 700. In such an embodiment, a trocar can be inserted into the subject, and the body-insertable device 776 can be inserted into a subject via the trocar. An individual operating the printing system 700 can guide the body-insertable device 776 using one or more sensors 732 attached to the body-insertable device 776 or one or more components of the printing system 700. The one or more sensor 732 can include a video camera with a cold light source (e.g., halogen or xenon). When the body-insertable device 776 reaches the internal region of interest 702, the control electrical circuitry 714 controllably steers one or more components of the printing system 700. For example, the control electrical circuitry 714 can controllably steer one or more components of the printing system 700 (e.g., the barrier 704, the printing head 708, etc.) to position the base contact surface 720 at least proximate to a surface 726.

In an embodiment, the printing system 700 can be used during the laparoscopic surgery. For example, the barrier 704 can be positioned such that the base contact surface 720 is positioned at least proximate to the surface 726. As such, the barrier 704 can isolate the internal region 706 from the external region 724 and at least partially prevent at least one contaminant (e.g., one or more body fluids) from entering the internal region 706. The one or more removal devices 710 can at least remove at least one contaminant present in the internal region 706. After the laparoscopic surgery is complete, the printing system 700 can be used to speed the healing process. For example, the one or more dispense elements 744 of the printing system 700 can controllably dispense biological materials into the subject such as tissue, grafts, or cells, such as printing tissue, capillaries, or similar structures within the body. The barrier 704 can substantially prevent at least one contaminant from interfering with the printing of the biological materials. In an embodiment, the printing system 700 can be configured to only be used during or after the laparoscopic surgery.

In an embodiment, the printing system 700 can be configured to be substantially inserted into the subject. For example, the printing system 700 can include a body-insertable device 776 that can be configured to at least partially house the printing head 708 along with the barrier 704, the one or more removal devices 710, or one or more additional components of the printing system 700. As such, the printing head 708 can be inserted into the subject along with the barrier 704, the one or more removal devices 710, or one or more components of the printing system 700. However, the printing system 700 can be configured to be inserted into the subject without the use of the body-insertable device 776.

In the illustrated embodiment, the controller 712 is illustrated to be remote from the printing head 708 and configured to not be inserted into the subject. However, in other embodiments, the controller 712 can be configured to be inserted subcutaneously. For example, at least a portion of the controller 712 can be positioned within the printing head 708.

The reader will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. The reader will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; alternatively, if flexibility is paramount, the implementer can opt for a mainly software implementation; or, yet again alternatively, the implementer can opt for some combination of hardware, software, and/or firmware. Hence, there are several possible vehicles by which the processes and/or devices and/or other technologies described herein can be effected, none of which is inherently superior to the other in that any vehicle to be utilized is a choice dependent upon the context in which the vehicle will be deployed and the specific concerns (e.g., speed, flexibility, or predictability) of the implementer, any of which can vary. The reader will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In an embodiment, several portions of the subject matter described herein can be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the reader will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital

Video Disk (DVD), a digital tape, a computer memory, etc.; and a transmission type medium such as a digital and/or an analog communication medium (e.g., a fiber optic cable, a waveguide, a wired communications link, a wireless communication link, etc.). In a general sense, the various embodiments described herein can be implemented, individually and/or collectively, by various types of electro-mechanical systems having a wide range of electrical components such as hardware, software, firmware, or virtually any combination thereof; and a wide range of components that can impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electro-mechanical systems include but are not limited to a variety of consumer electrical systems, as well as other systems such as motorized transport systems, factory automation systems, security systems, and communication/computing systems. Those skilled in the art will recognize that electro-mechanical as used herein is not necessarily limited to a system that has both electrical and mechanical actuation except as context can dictate otherwise.

In a general sense, the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). The subject matter described herein can be implemented in an analog or digital fashion or some combination thereof.

This disclosure has been made with reference to various example embodiments. However, those skilled in the art will recognize that changes and modifications can be made to the embodiments without departing from the scope of the present disclosure. For example, various operational steps, as well as components for carrying out operational steps, can be implemented in alternate ways depending upon the particular application or in consideration of any number of cost functions associated with the operation of the system; e.g., one or more of the steps can be deleted, modified, or combined with other steps.

Additionally, as will be appreciated by one of ordinary skill in the art, principles of the present disclosure, including components, can be reflected in a computer program product on a computer-readable storage medium having computer-readable program code means embodied in the storage medium. Any tangible, non-transitory computer-readable storage medium can be utilized, including magnetic storage devices (hard disks, floppy disks, and the like), optical storage devices (CD-ROMs, DVDs, Blu-ray discs, and the like), flash memory, and/or the like. These computer program instructions can be loaded onto a general purpose computer, special purpose computer, or other programmable data processing apparatus to produce a machine, such that the instructions that execute on the computer or other programmable data processing apparatus create a means for implementing the functions specified. These computer program instructions can also be stored in a computer-readable memory that can direct a computer or other programmable data processing apparatus to function in a particular manner, such that the instructions stored in the computer-readable memory produce an article of manufacture, including implementing means that implement the function specified. The computer program instructions can also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

In an embodiment, the printing systems disclosed herein can be integrated in such a manner that the printing systems operate as a unique system configured specifically for function of printing (e.g., three-dimensional printing), and any associated computing devices of the printing systems operate as specific use computers for purposes of the claimed system, and not general use computers. In an embodiment, at least one associated computing device of the printing systems operate as specific use computers for purposes of the claimed system, and not general use computers. In an embodiment, at least one of the associated computing devices of the printing systems are hardwired with a specific ROM to instruct the at least one computing device. In an embodiment, one of skill in the art recognizes that the printing devices and printing systems effects an improvement at least in the technological field of three-dimensional printing.

The herein described components (e.g., steps), devices, and objects and the discussion accompanying them are used as examples for the sake of conceptual clarity. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, the reader can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

In some instances, one or more components can be referred to herein as “configured to.” The reader will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications can be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense the convention (e.g., “a system having at least one of A, B, or C” would include but not be limited to systems that have A alone, B alone, C alone, A and B together, A and C together, B and C together, and/or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, the recited operations therein can generally be performed in any order. Examples of such alternate orderings can include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

While various aspects and embodiments have been disclosed herein, the various aspects and embodiments disclosed herein are for purposes of illustration and are not intended to be limiting, with the true scope and spirit being indicated by the following claims.

What is claimed is:

1. A printing system, comprising:
one or more dispense elements each of which includes at least one dispense aperture;
at least one material reservoir that is fluidly coupled to the one or more dispense elements, the at least one material reservoir including one or more at least partially solid materials disposed therein;
a barrier including an inner wall at least partially defining an internal region, an outer wall at least partially defining an external region, and a base contact surface extending between the inner wall and the outer wall, the barrier positioned or positionable so that the one or more dispense elements are positioned in or adjacent to the internal region of the barrier, wherein the base contact surface defines an opening;
wherein the one or more dispense elements are positioned and configured to controllably dispense at least the one or more at least partially solid materials through the at least one dispense aperture and toward the opening defined by the base contact surface to form a biocompatible three-dimensional structure on a region of interest; and
a controller including control electrical circuitry that is operably coupled to the one or more dispense elements, the control electrical circuitry configured to direct dispensing of at least the one or more at least partially solid materials from the one or more dispense elements.

2. The printing system of claim 1, wherein the internal region includes the region of interest at least partially positioned therein.

3. The printing system of claim 1, wherein the barrier completely laterally encloses a lateral periphery of the internal region.

4. The printing system of claim 1, wherein the barrier only partially laterally encloses a lateral periphery of the internal region.

5. The printing system of claim 1, wherein the barrier is further configured to at least partially prevent at least one contaminant present in the external region from entering the internal region.

6. The printing system of claim 5, wherein the at least one contaminant includes a gas and the barrier is at least semi-impermeable to the gas.

7. The printing system of claim 5, wherein the at least one contaminant includes a liquid and the barrier is at least semi-impermeable to the liquid.

8. The printing system of claim 1, wherein the base contact surface extends past the at least one dispense aperture of the one or more dispense elements.

9. The printing system of claim 1, wherein the barrier includes a cofferdam that at least partially laterally encloses the internal region.

10. The printing system of claim 1, wherein the barrier is configured to physically isolate the internal region from the external region.

11. The printing system of claim 1, wherein the barrier includes a seal defining or contacting the base contact surface, the seal configured to contact a surface including at least one of a portion of a region of interest; a region proximate to the region of interest; or a region that at least partially encloses the region of interest.

12. The printing system of claim 11, wherein the seal includes at least one of an adhesive sealant, a compressible material, a ferrofluid, a gasket, or grease.

13. The printing system of claim 1, further including a vacuum device at least partially disposed in the barrier, the vacuum device configured to vacuum seal the base contact surface against a surface, the surface including at least one of:
a portion of a region of interest;
a region proximate to the region of interest; or
a region that at least partially encloses the region of interest.

14. The printing system of claim 1, further including one or more flushing elements each of which includes at least one flushing aperture, the one or more flushing elements configured to controllably dispense one or more flushing agents towards a region of interest, at least one of the one or more flushing elements positioned in or near the internal region.

15. The printing system of claim 14, wherein the one or more flushing agents include a flushing gas.

16. The printing system of claim 15, wherein the flushing gas includes air, oxygen, a noble gas, carbon dioxide, nitrogen, or nitrogen dioxide.

17. The printing system of claim 14, wherein the one or more flushing elements are positioned and configured to dispense the one or more flushing agents in a direction towards the base contact surface of the barrier.

18. The printing system of claim 14, wherein the one or more flushing elements are configured to dispense the one or more flushing agents to create a pressure in the internal region that is greater than the pressure in the external region.

19. The printing system of claim 14, wherein the one or more flushing elements are directly attached to, incorporated into, or at least partially housed in the barrier.

20. The printing system of claim 1, further including one or more removal devices positioned and configured to remove at least one contaminant or substance from within or near the internal region.

21. The printing system of claim 20, wherein the one or more removal devices include at least one of a pump, a compressor, centrifugal fan, a vacuum pump or a micropump configured to remove the at least one substance from in or near the internal region.

22. The printing system of claim 20, wherein the one or more removal devices are configured to create a pressure in the internal region that is less than a pressure in the external region.

23. The printing system of claim 20, wherein the one or more removal devices are directly attached to, at least partially housed in, or integral with the barrier.

24. The printing system claim 20, wherein the removal device includes a pump or a micropump

25. The printing system of claim 1, further including a printing head that supports the one or more dispense elements.

26. The printing system of claim 25, further including one or more elongated members coupled to and extending from the printing head, the one or more dispense elements coupled to the one or more elongated members, the one or more elongated members configured to controllably steer the one or more dispense elements.

27. The printing system of claim 25, wherein the barrier is coupled to and extends from the printing head.

28. The printing system of claim 25, wherein the barrier is freestanding and is not coupled to the printing head.

29. A method of three-dimensional printing, the method comprising:
positioning one or more dispense elements at least proximate to a region of interest;
at least partially laterally surrounding an internal region with a barrier, the internal region including at least a portion of the region of interest therein, the barrier including an inner wall at least partially defining an internal region, an outer wall at least partially defining an external region, and a base contact surface extending between the inner wall and the outer wall, wherein the base contact surface defines an opening; and
with the barrier positioned to at least partially laterally surround the internal region, responsive to direction from control electrical circuitry, controllably dispensing at least one or more at least partially solid materials from the one or more dispense elements toward the opening defined by the base contact surface onto the region of interest to form a biocompatible three-dimensional structure.

30. The method of claim 29, wherein at least partially laterally surrounding the internal region with the barrier includes at least partially physically isolating the internal region from an external region.

31. The method of claim 29, wherein at least partially physically isolating the internal region from an external region is effective to at least partially prevent at least one contaminant in the external region from entering the internal region.

32. The method of claim 29, further including sealing the barrier against a surface, the surface including at least one of a portion of a region of interest; a region proximate to the region of interest; or a region that at least partially encloses the region of interest.

33. The method of claim 32, wherein sealing the barrier against the surface includes vacuum sealing the barrier against the surface.

34. The method of claim 32, wherein sealing the barrier against the surface includes pressure sealing the barrier against the surface.

35. The method of claim 32, wherein sealing the barrier against the surface includes positioning a seal, which is coupled to the barrier, to at least partially contact the seal against the surface.

36. The method of claim 32, sealing the barrier against the surface is effective to at least partially prevent at least one contaminant external to the barrier from entering the internal region.

37. The method of claim 29, further including controllably dispensing one or more flushing agents from one or more flushing elements toward the region of interest, at least one of the one or more flushing elements at least partially positioned in the internal region.

38. The method of claim 37, wherein dispensing one or more flushing agents from one or more flushing elements toward the region of interest at least partially prevents at least one contaminant external to the barrier from entering the internal region.

39. The method of claim 38, wherein dispensing one or more flushing agents from one or more flushing elements toward the region of interest generates a pressure that is greater in the internal region than a region external to the barrier.

40. The method of claim 29, further including removing at least one substance from the internal region at least partially defined by the barrier using a removal device.

41. The method of claim 40, wherein the removal device includes a vacuum device.

42. A printing system, comprising:
a body-insertable device configured to be inserted into a subject;
one or more dispense elements each of which includes at least one dispense aperture, the one or more dispense elements configured to controllably dispense one or more materials through the at least one dispense aperture;
a barrier including an inner wall at least partially defining an internal region, an outer wall, and a base contact surface extending between the inner wall and the outer wall, the barrier positioned or positionable so that the one or more dispense elements are positioned in or adjacent to the internal region of the barrier; and
a controller including control electrical circuitry that is operably coupled to the one or more dispense elements, the control electrical circuitry configured to direct dispensing of the one or more materials from the one or more dispense elements.

43. The printing system of claim 42, wherein the body-insertable device houses the one or more dispense elements.

44. The printing system of claim 43, wherein the body-insertable device further houses the barrier.

45. The printing system of claim 42, wherein the body-insertable device includes an endoscope having at least one channel that at least partially houses the one or more dispense elements.

46. The printing system of claim 45, wherein the at least one channel houses the barrier

47. The printing system of claim 45, wherein the barrier is positioned in at least one additional channel that is remote from the at least one channel, at least one additional channel that is adjacent to the at least one channel, or positioned around the at least one channel.

48. The printing system of claim 42, further including a seal coupled to the barrier that is configured to contact an internal surface of the subject.

49. The printing system of claim 42, further including one or more flushing elements each of which includes at least one flushing aperture, the one or more flushing elements configured to controllably dispense one or more flushing agents in a direction away from the base contact surface of the barrier.

50. The printing system of claim 42, further including one or more removal devices configured to remove at least one contaminant from the internal region at least partially defined by the barrier.

51. The printing system of claim 1, wherein the region of interest includes an internal anatomical site of a living subject.

52. The method of claim 29, wherein dispensing at least the one or more at least partially solid materials from the one or more dispense elements onto the region of interest includes dispensing at least the one or more at least partially solid materials from the one or more dispense elements onto an internal anatomical site of a living subject.

53. The printing system of claim 11, wherein the seal only forms a portion of the barrier.

54. The printing system of claim 1, wherein the one or more at least partially solid materials includes one or more metallic materials, one or more ceramic materials, one or more polymeric materials, one or more polymer fibers, one or more microfibers, one or more nanofibers, one or more thermo-responsive polymers, one or more phase change polymers, or one or more tissues.
